(19) United States
(12) Patent Application Publication
(10) Pub. No.: US 2004/0205040 A1
(43) Pub. Date: Oct. 14, 2004

(54) Experience-knowledge information processing apparatus

(75) Inventors: Takeshi Yoshioka, Kanagawa (JP); Hiroki Yoshimura, Kanagawa (JP); Hiroshi Masuichi, Kanagawa (JP); Tomoko Ohkuma, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/822,849

(22) Filed: Apr. 13, 2004

(30) Foreign Application Priority Data
Apr. 14, 2003 (JP) 2003-108640
Mar. 26, 2004 (JP) 2004-092029

(51) Int. Cl. G06F 7/00; G06F 17/00; G06N 5/02

(52) U.S. Cl. 706/50; 706/46

(57) ABSTRACT

An experience-knowledge information processing apparatus that manages knowledge acquired from personal experiences so as to reuse the knowledge easily. Preferably, when information about knowledge acquired from a personal experience is inputted by a client, a server performs a process for associating the knowledge with an activity where the experience has been gained, and associating the knowledge with a knowledge creation process expressing a process for creating the knowledge on the basis of the description of the questionnaire. Thus, the knowledge information associated thus is accumulated in an experience-knowledge database. A two-dimensional table indicating the total number of pieces of knowledge with activities and knowledge creation processes in columns and rows, a knowledge propagation state graph, or the like, is displayed and outputted by a process of an experience-knowledge processing portion based on the information accumulated in the experience-knowledge database.

### BACKGROUND OF THE INVENTION

1. Field of the Invention

The present invention relates to a technique for processing information of knowledge possessed by individuals, and particularly relates to a technique which can be used for supporting management of an enterprise and/or an organization utilizing such knowledge.

2. Background Art

Knowledge is an asset to an organization made up of a plurality of members, such as an enterprise or a research center. For example, a large number of enterprises have grappled with knowledge management, asserted the importance of the knowledge management and knowledge administration, and built knowledge management systems using IT (information processing technique).

Most of the current knowledge management systems are however systems mainly related to manuals, reports, etc. formed into databases. In such a system, documents already made use of by individuals or in an organization are stored in a database with indexes such as keywords being added to the documents, so that the documents can be retrieved and hence superficial knowledge (explicit knowledge) can be shared.

Of knowledge as a target of knowledge management, some are indeed superficial knowledge (explicit knowledge) as mentioned above, but some are subjective knowledge (tacit knowledge) such as know-how, skills, intuition, etc. The tacit knowledge is acquired based on past experiences of the organization or members in the organization but has not yet been expressed to be able to be shared with other members, especially those in a third party.

The document “The Knowledge-Creating Company” says that it is important to create knowledge through interaction between the explicit knowledge and the tacit knowledge. Thus, an SECI model is proposed (see “The Knowledge-Creating Company How Japanese Companies Create the Dynamics of Innovation”, by Ikujiro Nonaka and Hirotaka Takeuchi, Oxford University Press, 1995).

The SECI model is composed of four knowledge creation process activities, that is, socialization (S), externalization (E), combination (C), and internalization (I). In the socialization, tacit knowledge of one individual is acquired as tacit knowledge of another individual through a group work, etc. In the externalization, tacit knowledge of a certain individual is expressed with the help of metaphors or the like, and converted into explicit knowledge. In the combination, one piece of explicit knowledge combined with another piece of explicit knowledge is expressed in a document or the like so that a new piece of explicit knowledge is created. In the internalization, explicit knowledge is learned so that a new piece of tacit knowledge is created.

By use of this SECI model, some enterprises have practically achieved successful knowledge management.

In addition, there has been proposed a system in which evaluation templates corresponding to the SECI model are prepared, individuals or an organization uses these templates to evaluate daily business from the viewpoint of the SECI model, and a computer makes analysis on the evaluation and presents the condition of the business (see JP-2002-157415).

With each evaluation template, a time allocation and an importance value are evaluated stepwise for each of a plurality of typical example sentences corresponding to each process of S, E, C and I. The results are compiled and displayed in graphs. In addition, some contrivances are proposed as follows. That is, in the process of the externalization (E), tacit knowledge is expressed by a construction of a sentence with blanks such as “this is very ______ for ______”, and a plurality of tacit knowledge expression templates are prepared so that the tacit knowledge is extracted by filling the blanks with words. Or a user is allowed to select terms such as a subject to fill the blanks, an object, an event predicate, a focus, and so on, from a thesaurus prepared in advance and including such terms. Thus, tacit knowledge is externalized.

Further, there has been proposed another system in which the characteristic of how to work individually, the characteristic of how to work in an organization, and the characteristic indicating sources of current and future profits are surveyed by questionnaire and correlation among these characteristics is analyzed so as to assess and diagnose enterprise management from the viewpoint of knowledge creation and utilization (see JP-2002-207844).

In addition, there has been proposed further another system in which a handbook of processes inclusive of business processes and having is-a and has-a relations among them is proposed, and general business processes in the proposed handbook are categorized into four, that is, design, purchase and supply, manufacturing, sales and shipment, and management, while each registered activity is associated with a business process in an is-a or has-a relation (see U.S. Pat. No. 6,349,298 or T. W. Malone et al., Management Science, 45, pp. 425-443, 1999).

### SUMMARY OF THE INVENTION

To perform business in an organization such as an enterprise or a department in the enterprise, tacit knowledge such as know-how, skills, intuition, etc., which is not expressed in the form of a document or the like, is used together with explicit and superficial knowledge. The tacit knowledge is acquired and accumulated by each organizational member through his/her own experience and reused in subsequent experiences.

According to the suggestion made by “The Knowledge-Creating Company”, by Ikujiro Nonaka and Hirotaka Takeuchi, Oxford University Press, 1995, and the like, it is important to externalize knowledge acquired from an experience, share the knowledge in the organization and create new knowledge.

Most of the background-art techniques for knowledge management systems are, however, mainly related to manuals, reports, etc. formed into databases. In such a system, documents already made use of by individuals or in an organization are stored in a database with indexes such as keywords being added to the documents, so that the documents can be retrieved and hence superficial knowledge (explicit knowledge) can be shared. That is, the techniques are not aimed at extracting knowledge acquired from personal past experiences and sharing the knowledge in association with business activities.

The background-art technique for extracting tacit knowledge by questionnaire or the like is provided for finding out a perspective tendency of empirical knowledge used in the organization. Even by use of the technique, it is however difficult to grasp the reuse state of specific experience-knowledge acquired from a personal business activity in the past, grasp the relation between one piece of experience-knowledge and another piece of experience-knowledge in a business activity or the propagation state of the knowledge, or compare the reuse state in one job category or one organization with that in another. In addition, there is a problem that knowledge acquired from past business activities is not organized whether it is based on a successful experience or it is about an activity based on a failure activity and should not be redone.

For example, in JP-2002-157415, an enterprise management system using knowledge including not only explicit knowledge but also tacit knowledge has been proposed. According to JP-2002-157415, evaluation templates using example sentences are used to evaluate a degree of each knowledge creation process corresponding to each process of S, E, C and I. It is however difficult to share and reuse knowledge practically experienced by users unless the knowledge is externalized. The externalized knowledge corresponds to an object, a subject, an event predicate, a focus, etc. It is however difficult to explicitly extract a knowledge process or a business activity in which the externalized knowledge has been acquired from an experience as the source of the knowledge. In addition, it is difficult to find out business activities where knowledge has been acquired, that is, to find out which business activity has a deep relation to knowledge creation. In addition, it is also difficult to make a judgment as to whether the externalized knowledge has been used in a subsequent specific business case or not. In addition, there is a problem that the externalized knowledge is not designated to which it is effective.

In JP-2002-207844, consciousness and experience of each organizational member are associated with each other. According to JP-2002-207844, the tendency of an organization or an enterprise as a whole is merely evaluated but it is impossible to grasp whether a specific personal experience in the past has been put to successful use in current business activities or not.

For the purpose of extracting and organizing experience-knowledge useful for individuals, an attempt is also made to conduct interviews with top executives and middle managers as to their mature experiences and organize the experiences in a table. In this attempt, events where the mature experiences were gained, knowledge acquired from the events and periods when the knowledge was acquired are organized. However, the attempt depends on the interviews needing know-how proper to an interviewer. In addition, in the same manner as in the proposal of JP-2002-157415, how the knowledge has been put to use since then is not organized.

As described above, there is a problem in the background-art techniques that knowledge acquired from an experience cannot be associated with a business activity or a knowledge creation process. In addition, there is another problem that cases showing how the acquired knowledge could be reused cannot be provided. Further, it is also difficult to look over the knowledge acquired from an experience in accordance with each business activity or each knowledge creation process, or to find out the reuse state of the knowledge. Particularly, it is difficult to grasp the state in which experience-knowledge of one individual member in an organization or enterprise is propagated to another member in the same organization or enterprise and reused beyond time and space.

Also in T. W. Malone et al., Management Science, 45, pp. 425-443, 1999, knowledge and a business activity process can be associated with each other. It is however impossible to grasp the state in which experience-knowledge of one individual member in an organization or enterprise is propagated to another member in the same organization or enterprise and reused beyond time and space. Further, it is impossible to analyze texts in sentences inputted by individuals and associate the sentences with business activity processes. For this reason, an administrator has to analyze and register the se proper texts for knowledge sharing manually. Thus, a large amount of man-hours and personal know-how are required. General categories of business activities are suitable for classifying total activities of enterprises not in view of values but based on visibles such as products or services. Thus, there is a problem that it is difficult to classify added values provided by individuals such as staffs into an activity which is a constituent of a business process.

In order to solve the problems, an object of the invention is to manage knowledge acquired from personal experiences in a reusable form.

The invention has other objects: that is, to input knowledge (explicit knowledge and tacit knowledge) acquired from a personal experience in sentences concerning acquisition and use of experience-knowledge possessed by an individual by means of electronic questionnaire or the like, analyze the knowledge automatically, and associate the knowledge with a business activity and a knowledge process; to make clear the state that the knowledge acquired from the experience has been propagated and reused; and to provide cases as sources of the knowledge acquired from the experience and cases of reuse of the knowledge, and provide context information for sharing and reusing the knowledge, so as to make it easy to share and reuse the knowledge.

Further another object of the invention is to provide a graphical representation in which knowledge acquired from experiences can be looked over to make it easy to know the distribution and reuse state of experience-knowledge in an organization or an enterprise.

The invention is expressed in forms of information processing apparatus in terms of knowledge creation and reuse based on individual experienceexperience-knowledge, a program for implementing the apparatus with a computer, and an experience-knowledge information processing method in terms of knowledge creation and reuse based on individual experience. Hereafter knowledge based on individual knowledge is called experience-knowledge.

According to the invention, management is achieved using a database through the following processing. That is, on the basis of information inputted from an individual, including information about a personal experience gained from a past activity, information about knowledge acquired from the experience and information about application of the knowledge, the information about the personal experience and the information about application of the knowledge are associated with an activity where the experience has been gained. The information about the acquired knowledge is also associated with a knowledge creation process expressing a process for creating the knowledge. Thus, knowledge acquired from an experience is associated with an activity and a knowledge creation process where the experience has been gained or the knowledge has been applied.

Further, according to the invention, on the basis of inputted information including information about a personal experience gained from a past activity, information about knowledge acquired from the experience and information about application of the knowledge, an activity corresponding to the experience from which the knowledge has been acquired and an activity to which the knowledge has been applied are identified, and the total number of pieces of knowledge acquired or applied is calculated in accordance with each activity.

Further, according to the invention, on the basis of inputted information including information about a personal experience gained from a past activity, information about knowledge acquired from the experience and information about application of the knowledge, a knowledge creation process of the knowledge acquired from the experience is identified, and the total number of pieces of knowledge acquired or applied is calculated in accordance with each knowledge creation process.

Further, according to the invention, on the basis of inputted information including information about a personal experience gained from a past activity, information about knowledge acquired from the experience, information about application of the knowledge, information about a job category where the experience has been gained, and information about a job category to which the knowledge has been applied, the total number of pieces of knowledge acquired or applied is calculated in accordance with each job category.

In addition to management based on calculation of the number of pieces of knowledge as described above, according to the invention, propagation of knowledge is also managed. That is, on the basis of inputted information including information about a period of an experience, information about knowledge acquired from the experience, and information about an individual possessing the knowledge, the propagation state of the knowledge among individuals is analyzed, and the analyzed propagation state of the knowledge is displayed and outputted.

Further, according to the invention, the propagation velocity is calculated based on the propagation state of the knowledge among the individuals so that the degree of recycling in knowledge propagation is managed.

According to the invention, a flow from acquisition of experience-knowledge possessed by an individual to use of the experience-knowledge is inputted and analyzed as a personal problem-solving story so that the flow of personal experience-knowledge can be looked over in association with a business activity.

More specifically, by means of questionnaire or the like, information about a personal important experience in the past and sentences about experience-knowledge acquired from the experience and application of the experience-knowledge are inputted as a simple story in order of time, and an inputted text including the information and the sentences is analyzed, so that a relation set of relevant words extracted from the inputted text is compared with a set of activity definition words registered in an activity dictionary, with the result that a relevant business activity can be specified.

Further, the relation set of relevant words extracted from the inputted text is compared with a set of definition words of knowledge creation and reuse process registered in a knowledge process dictionary so that a relevant knowledge creation activity can be specified.

Further, information about use of knowledge acquired from an important experience in the past is inputted, and a relevant business activity is extracted by use of a unit similar to that for the information about an important experience in the past.

Information about reuse of the experience-knowledge is accumulated in a storage unit together with the important experience in the past.

In addition, there is provided a unit for inputting time information about experience period (knowledge acquisition period or the like) and experience-knowledge reuse (knowledge application period or the like) and an acquisition method, calculating the relation between one piece of experience-knowledge and another piece, and forming and displaying a network concerning the propagation of the knowledge.

Further, activities associated with the set of activity definition words registered in the activity dictionary are associated with five categories of activities, that is, input, process and output business activities directly related to a value chain of “to acquire a value source such as a material”, “to create a value” and “to provide the value”, a business activity for designing the value, and a business activity for managing the aforementioned activities. Thus, comparison as to a flow from acquisition of experience-knowledge to use of the experience-knowledge, that is, a use path of the experience-knowledge can be made between job categories or between organizations.

In addition, there is provided a unit for making comparison in reuse state among accumulated pieces of experience-knowledge by use of attribute information of the experience-knowledge such as relevant activities, relevant knowledge processes, knowledge acquisition/application periods, etc., and respondents' organization information such as job categories, organization names, etc. There is further provided a unit for associating the knowledge creation activities with categories of respective knowledge creation activities such as categories in an SECI model, and looking over the relations between the knowledge creation activities and the business processes in a lump.

There is further provided graphical representation such as a a display unit for displaying a use path of experience-knowledge by overview in accordance with any two items selected from business process, knowledge creation process, job category, organization, time, etc. while also displaying a category of another item with an attribute such as the color in which the path is to be displayed.

Here, states of acquisition and application of knowledge as a target of the invention is shown, for example, in FIG. 31.

In a situation such as business performance, an individual conducts several activities such as a slip processing business, a shipping business, and an order business. These past activities become an experience for the individual, who acquires tacit knowledge by this experience. This tacit knowledge, i.e., an experience, is converted by the SECI process (the knowledge creation process) into explicit knowledge, i.e., knowledge, and applied to a new activity, and the business is performed.

Such an application of knowledge is also conducted by the SECI process (knowledge creating process). In accordance with each element of a recycling process of knowledge of an individual a cycle is repeated: gaining an experience from an activity, acquiring knowledge from the experience through the SECI, applying the knowledge to a new activity through SECI, and gaining a new experience from the new activity.

Thus, according to the invention, a management of knowledge based on a personal experience is realized by information processing technology for reuse of knowledge which converts an experience gained from a past activity into knowledge by a knowledge creating process and applies a knowledge to a new activity.

[Effect of the Invention]

As described above, according to the invention, experience-knowledgeexperience-knowledge of an individual can be extracted from an experience and associated with a business activity where the individual gained the experience actually in the past, or the experience-knowledgeexperience-knowledge acquired by the individual can be associated with a knowledge creation process or further associated with application of the experience-knowledgeexperience-knowledge in subsequent business. Thus, the experience-knowledgeexperience-knowledge can be easily reused in an organization such as a department or an enterprise.

According to the invention, for example, experience-knowledge in an organization can be mapped so that there is an effect that the knowledge reuse state in the organization can be grasped easily and used for taking a measure and making a plan in knowledge management. Experience-knowledge of an individual is inputted and answered in a text and in the form of a story by means of questionnaire, so that tacit knowledge can be externalized easily. Business activities are categorized into input, process and output activities related to a value chain, an activity for designing the value chain activities, and an activity for managing these activities. Thus, experience-knowledge can be compared between different job categories or between different industry categories so that there is an effect that knowledge can be easily reused and transferred across organizations.

### BRIEF DESCRIPTION OF THE DRAWINGS

The present invention may be more readily described with reference to the accompanying drawings:

FIG. 1 is a view showing the configuration of an information processing system according to an embodiment of the invention;

FIG. 2 is a view showing a hardware configuration of each of client computers and a server computer according to the embodiment of the invention;

FIG. 3 is a view showing a functional configuration of the server according to the embodiment of the invention;

FIG. 4 is a view showing an example of organization information registered in an individual and organization database;

FIG. 5 is a view showing an example of individual information registered in the individual and organization database;

FIG. 6 is a view showing an example of an experience-knowledge survey result registered in an experience-knowledge database;

FIG. 7 is a view showing an example of an experience-knowledge extraction result registered in the experience-knowledge database;

FIG. 8 is a view showing an example of an electronic questionnaire;

FIG. 9 is a view showing an example of an activity dictionary registered in a dictionary database;

FIG. 10 is a view showing an example of a set of activity definition words in the configuration of the activity dictionary;

FIG. 11 is a view showing an example of a tree structure indicating upper and lower relations in activity categories;

FIG. 12 is a view showing an example of a knowledge process dictionary registered in the dictionary database;

FIG. 13 is a view showing an example of a set of definition words of knowledge creation and reuse process in the configuration of the knowledge process dictionary;

FIG. 14 is a view for explaining an outline of a processing example by a knowledge analysis portion;

FIG. 15 is a view for explaining an example of a business activity extraction algorithm;

FIG. 16 is a view showing an example of the activity dictionary registered in the dictionary database;

FIG. 17 is a view for explaining an example of a semantic analysis result and a business activity extraction result of a described text of business experience;

FIG. 18 is a view showing a display example of individual experience-knowledge;

FIG. 19 is a view showing an example of an experience-knowledge propagation graph;

FIG. 20 is a view showing an example of an experience-knowledge propagation velocity comparison table;

FIG. 21 is a view showing an example of a knowledge map (with business activities and knowledge creation processes in columns and rows);

FIG. 22 is a view showing a modification example of the knowledge map (with business activities and knowledge creation processes in columns and rows);

FIG. 23 is a view showing an example of the knowledge map (with business activities and job categories in columns and rows);

FIG. 24 is a view showing an example of the knowledge map (with job categories and knowledge creation processes in columns and rows);

FIG. 25 is a view showing an example of the knowledge map (with business activities and (experience periods/application periods) in columns and rows);

FIG. 26 is a view showing an example of the knowledge map (with job categories and (experience periods/application periods) in columns and rows);

FIG. 27 is a view showing an example of the knowledge map (with knowledge creation processes and (experience periods/application periods) in columns and rows);

FIG. 28 is a view showing an example of definition of synonymous rule;

FIG. 29 is a view explaining an example of algorithm of separating a problem, experience-knowledge, an application case, application target etc. from questionnaire response text;

FIG. 30 is a view explaining an example of extracting algorithm of a knowledge creating process; and

FIG. 31 is a view explaining concept of activity, experience-knowledge, application and knowledge creation processes according to the invention.

### DETAILED DESCRIPTION OF THE PREFERRED EMBODIMENTS

The invention will be described specifically in conjunction with its embodiment.

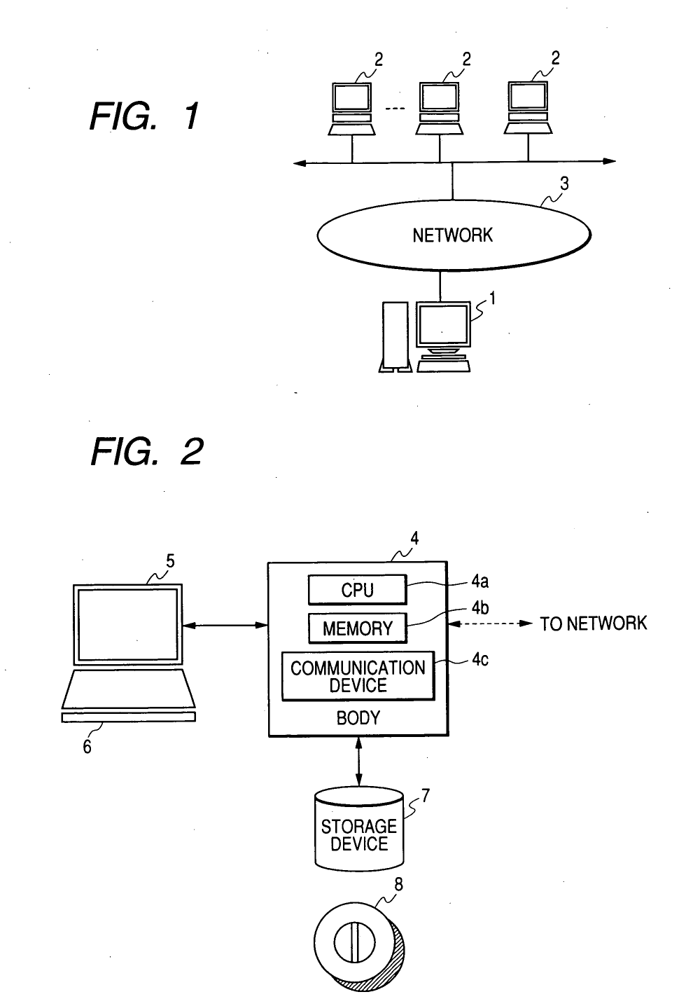

FIG. 1 shows an experience-knowledge information processing system according to an embodiment of the invention. Incidentally, although the system configuration is based on a client-server mode in this embodiment, the invention is applicable to any system configuration such as a system based on a network mode for carrying out distributed processing, or a system based on a stand-alone mode.

Each functional unit which will be described later is implemented by execution of a program according to the invention in a client computer or a server computer according to the embodiment. The functional unit may be formed as a module of dedicated circuitry.

For example, the system according to the embodiment is a wide area network (WAN) or a local area network (LAN) constructed over a plurality of offices in an enterprise or in a supply chain. The system according to the embodiment includes a server computer 1 for carrying out principal processes according to the invention such as an analysis/evaluation process, client computers 2 for accepting inputs from individual users such as organizational members and providing processing results of the inputs, and a network 3 through which the server computer 1 and the client computers 2 are connected to each other.

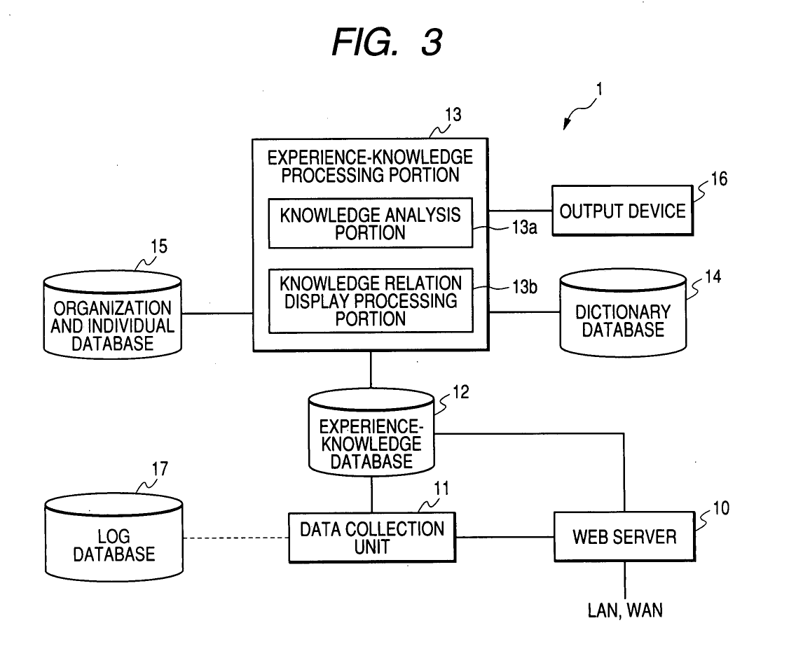

FIG. 2 shows a hardware configuration of a computer constituting the server computer 1 or each client computer 2.

Each of the server computer 1 and the client computers 2 has a body 4, a liquid crystal display (screen display device) 5, an input device 6, and an external storage device 7. The body 4 includes a processor (CPU) 4a for carrying out various processes in accordance with a program, an internal memory 4b for forming a CPU working area or a program or data storage area, a communication device 4c for carrying out a communication process through the network 3, etc. The input device 6 includes a keyboard and a mouse (not shown). The external storage device 7 includes an HDD, a CD device, etc.

A client program operating on each client computer 2 includes a user interface portion (UI portion), a browser program and a LAN communication control portion.

For example, the client program is supplied to the storage device 7 of the client computer 2 through a recording medium 8, loaded onto the memory 4b and executed by the CPU 4a. The client program uses these constituent elements to provide WWW-browsing and input functions to an organizational member (user) using the client computer 2.

In the client program, the UI portion accepts operation made on the input device 6 by the user and controls processes of respective constituent parts of the client program. Further, the UI portion displays data received from the network 3 by a web browser, to the user via the screen display device 5. The LAN communication control portion controls communication with another client computer 2 or the server 1 (each constituent portion serving as a communication subject is generically referred to as “communication node”) and communication with another communication node through the network 3 such as a LAN. The web browser provides the user of the client computer 2 with the WWW-browsing function and the input function.

As will be described later, when a questionnaire is sent to each member to survey useful past experiences etc., the web browser displays necessary questions for the questionnaire survey received from a web server of the server 1, on the screen display device 5 so as to present the questions to the user. In the questionnaire survey, for answering the questions from the web server displayed on the browser of the client computer 2, for example, each member may write answers in the form of sentences using the input device 6 or select one from choices prepared in advance. Incidentally, as other methods, there may be conceived a method of distributing questionnaires to the members and inputting answers written on the questionnaires into the server 1 by manual operation or OCR, or a method of making the members designate files of documents described about useful experiences. As a typical example, a web questionnaire which is an electronic questionnaire will be described in this embodiment.

In a web questionnaire survey, when each survey target (member) inputs answers to the questions displayed on the browser by use of the input device 6, the web browser accepts the answers and sends them to the server 1 through the network 3. The server 1 performs an analysis/evaluation process on the answers.

On this occasion, the client 2, the web server (server 1), etc. can automatically add, to the answers, identification information of the survey target and date and time of the answers necessary for analysis/evaluation of the answers, or the survey target can make an explicit operation on the browser to add such information to the answers. That is, identification information of the respondent user and date and time of the answers are added to the answers to the questionnaire.

The browser program also has a function of checking whether the survey target has entered all the necessary items in the questionnaire or not, adding tags or the like to questionnaire results (answers) in accordance with each item and sending the questionnaire results in a form in which each result can be separated by the server 1.

In addition, the web browser together with the browser program provides a function of looking over important experiences and knowledge in the past and retrieving them. For example, the web browser displays, on the screen, a menu for retrieval items of the important experiences and knowledge in the past, and the browser program generates a database retrieval query etc. in accordance with the retrieval item specified by the user and sends the database retrieval query etc. to the server 1. Alternatively, only the item specified by the user may be sent so that the retrieval query is generated on the server program side.

FIG. 3 shows the configuration of principal functions implemented by a server program operating on the server 1.

Incidentally, in the same manner as described above, these functional portions may be formed, for example, by the server program supplied to the storage device 7 of the server computer 1 through the recording medium 8, loaded onto the memory 4b and executed by the CPU 4a.

The server 1 has a web server 10, a data collection unit 11, an experience-knowledge database 12, an experience-knowledge processing portion 13, a dictionary database 14, an organization and individual database 15, and an output portion 16. The web server 10 has a WWW service function for providing a questionnaire to be displayed and accepting input of results (answers) of the questionnaire. The data collection unit 11 compiles the questionnaire results. The experience-knowledge database 12 stores the questionnaire results and experience-knowledge extracted from the questionnaire results. The experience-knowledge processing portion 13 has a knowledge analysis portion 13a for analyzing experience-knowledge from the questionnaire results and a knowledge relation display processing portion 13b for calculating a relation between one piece of the experience-knowledge and another piece and displaying the relation. The dictionary database 14 stores dictionaries such as sets of words associated with business activities and knowledge creating processes. The organization and individual database 15 stores individual and organization information concerning questionnaire respondents. Incidentally, as indicated by the broken line in FIG. 3, a log database 17 may be further added in accordance with necessity.

When a questionnaire survey of past experiences and knowledge is conducted, the web server 10 receives questions necessary for the questionnaire survey from the experience-knowledge processing portion 13, and displays the received questions on the display device 5 of the client computer 2 through the web browser operating on the client computer 2.

In addition, the server 1 also has a function of retrieves contents of experiences and knowledge accumulated in the experience-knowledge database 12 through the experience-knowledge processing portion 13 in accordance with a request from the user, processing a result into a form suitable for the user, and displaying the result.

The data collection unit 11 sends a log of the questionnaire stored in the log database 17 to the experience-knowledge processing portion 13 etc. in accordance with the necessity.

Here, in the embodiment explained in detail below, a web server 10 configures an input means in a text form, for example, to input information about a personal experience gained in a past activity, information about knowledge acquired from the experience, information about application of knowledge, information about a period of experience when knowledge is acquired and information about an individual possessing the knowledge.

In addition, in the embodiment explained in detail below, a knowledge analysis portion 13a configures a functional means to conduct a process of associating information about an experience and information about application of knowledge with information about an experienced activity, a process of identifying an activity corresponding to an experience from which knowledge has been acquired, a process of identifying an activity where knowledge has been acquired from an experience or the knowledge has been applied, a process of identifying a job category where the experience has been gained or the knowledge has been applied, a process of identifying a knowledge creating process where knowledge has been acquired from an experience, a process of identifying a knowledge creating process where knowledge has been applied to a new activity, a process of identifying a knowledge creating process, a process analyzing a state of propagation of knowledge among individuals, a process of calculating a velocity of propagation of knowledge among individuals, a process of calculating a total number of pieces of knowledge acquired or applied in accordance with each activity, a process of calculating a total number of pieces of knowledge acquired or applied in accordance with each knowledge creation process, a process of calculating a total number of pieces of knowledge acquired or applied in accordance with each job category, a process of calculating a total number of pieces of knowledge acquired or applied in accordance with each period of experience, and the like.

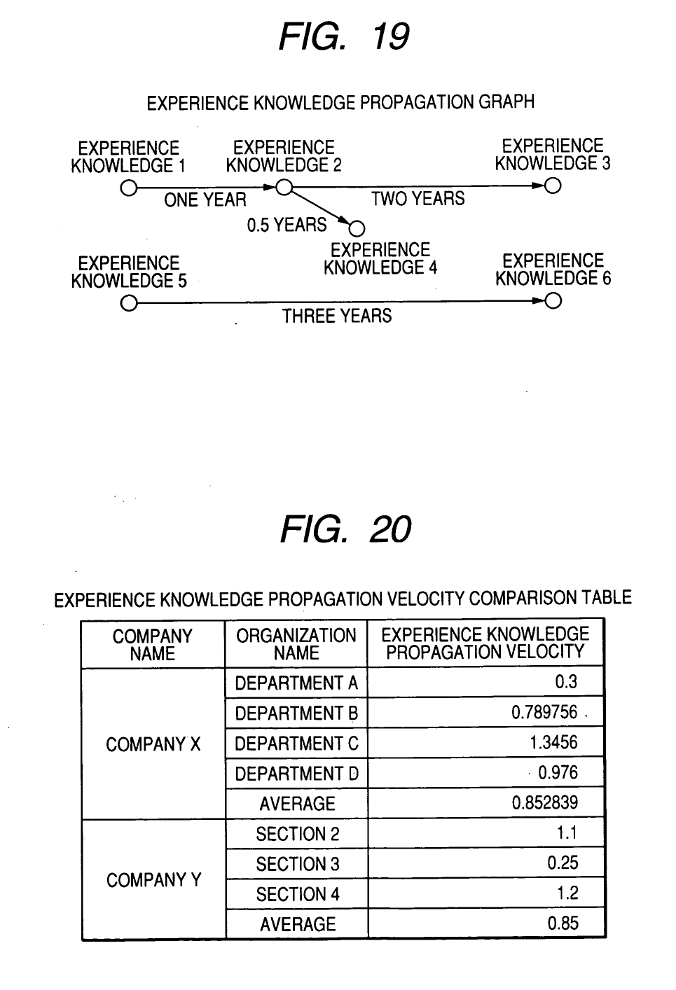

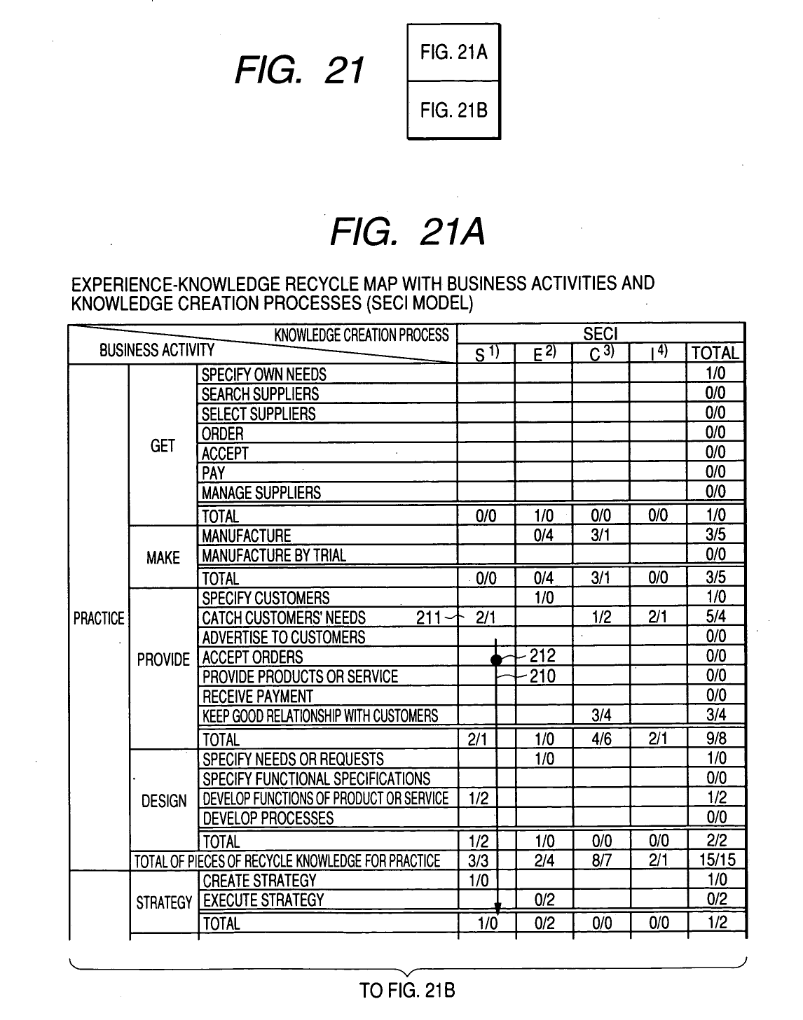

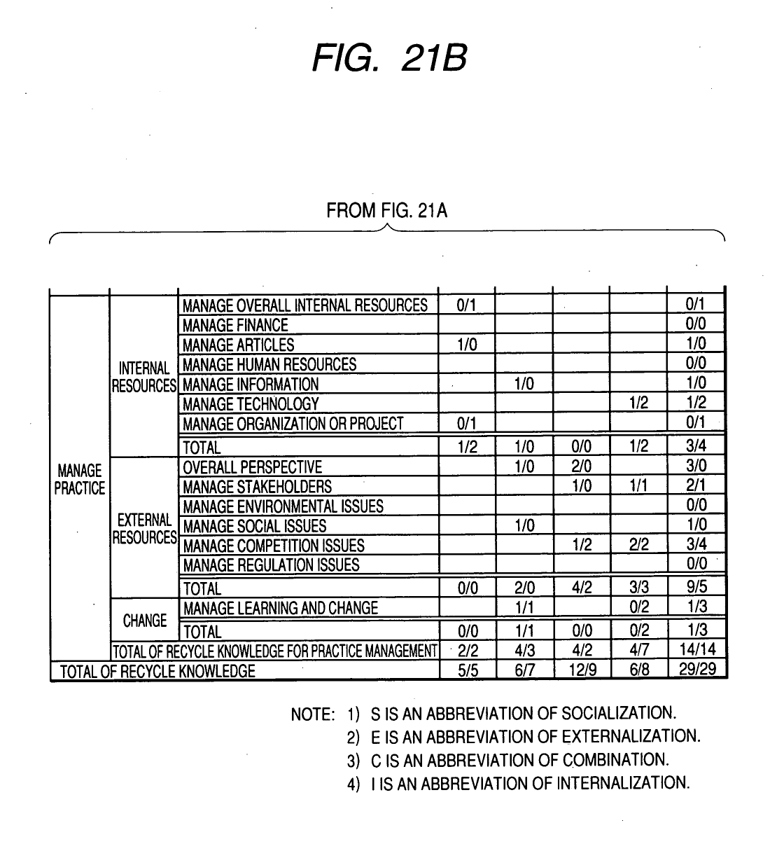

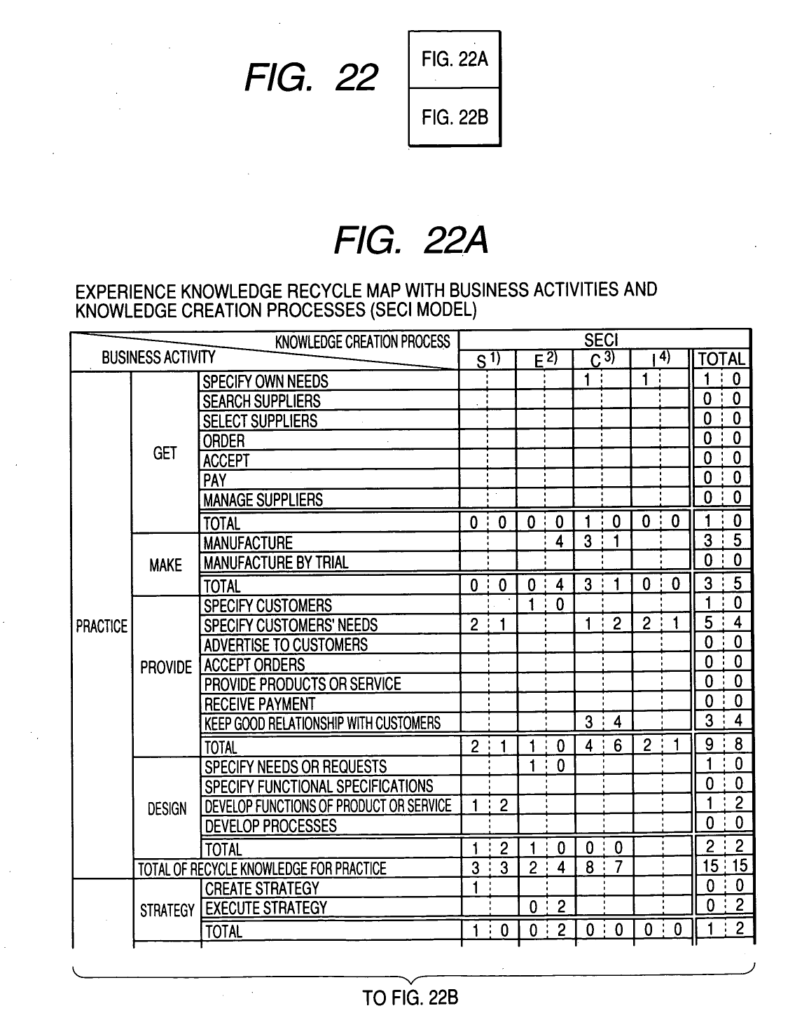

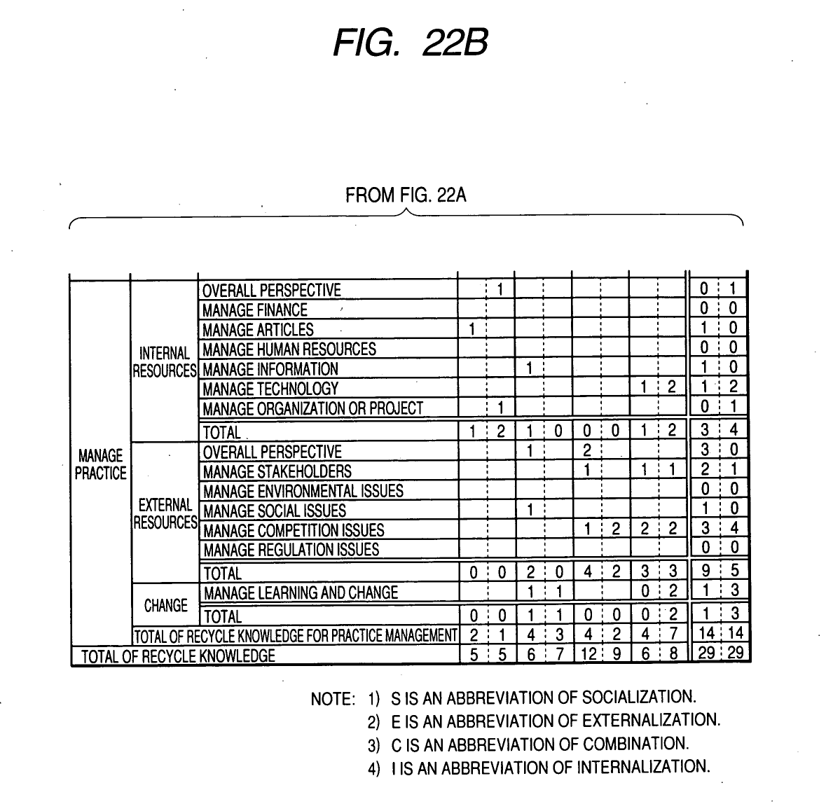

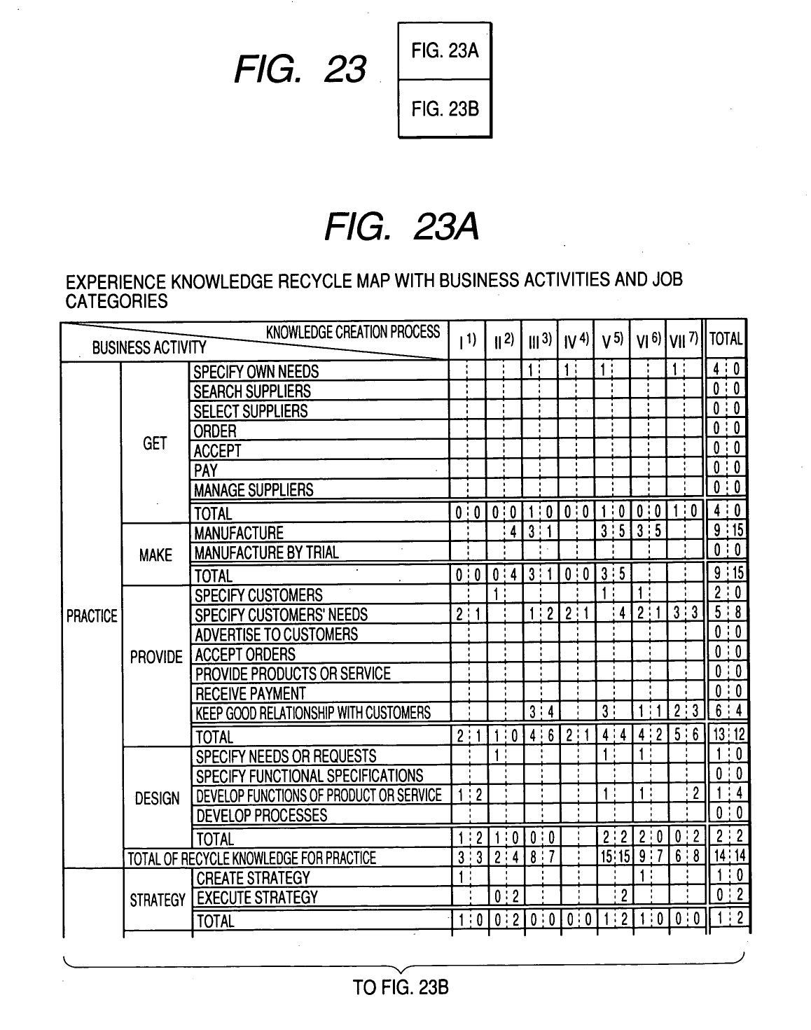

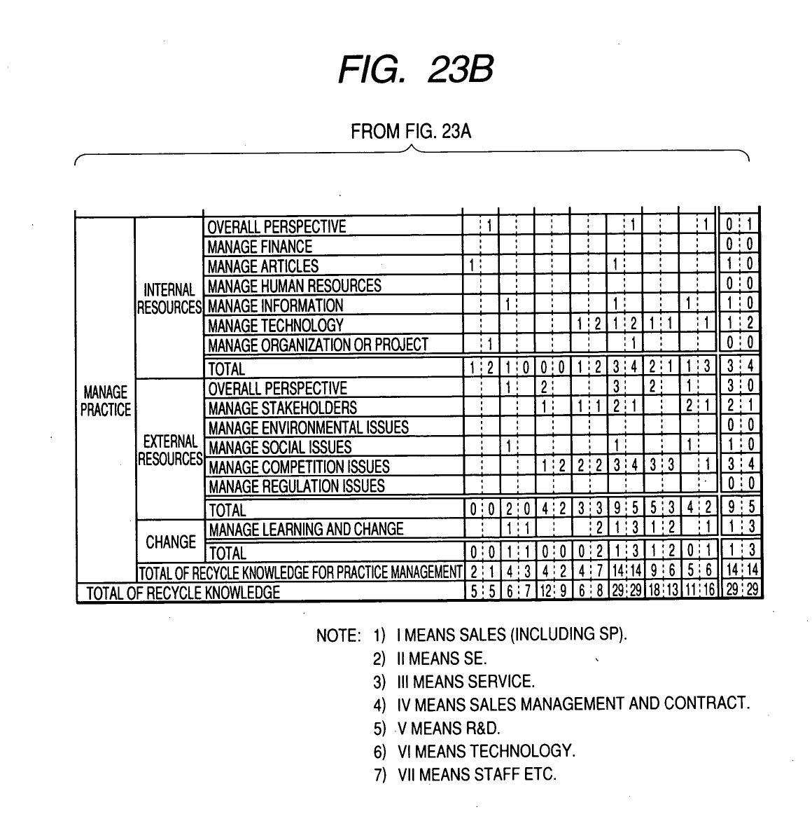

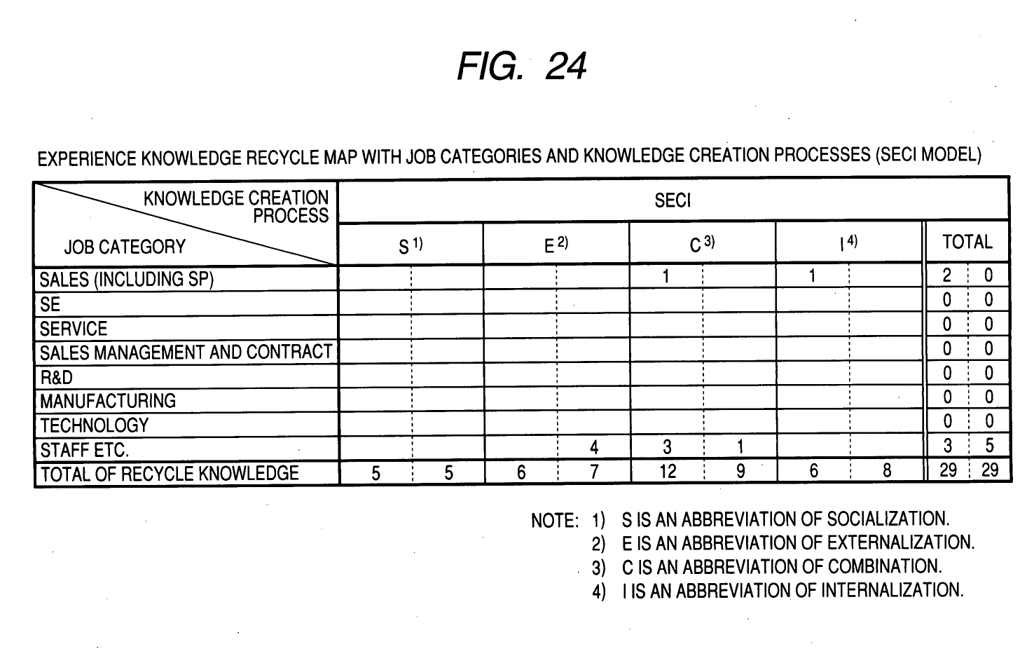

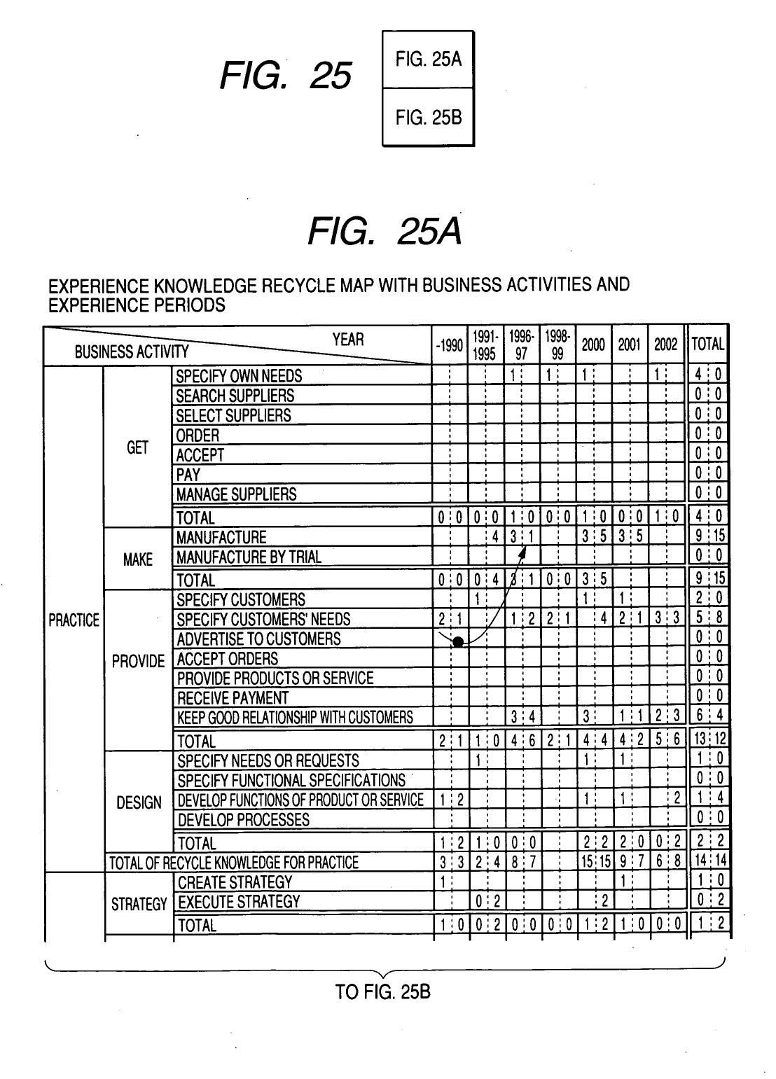

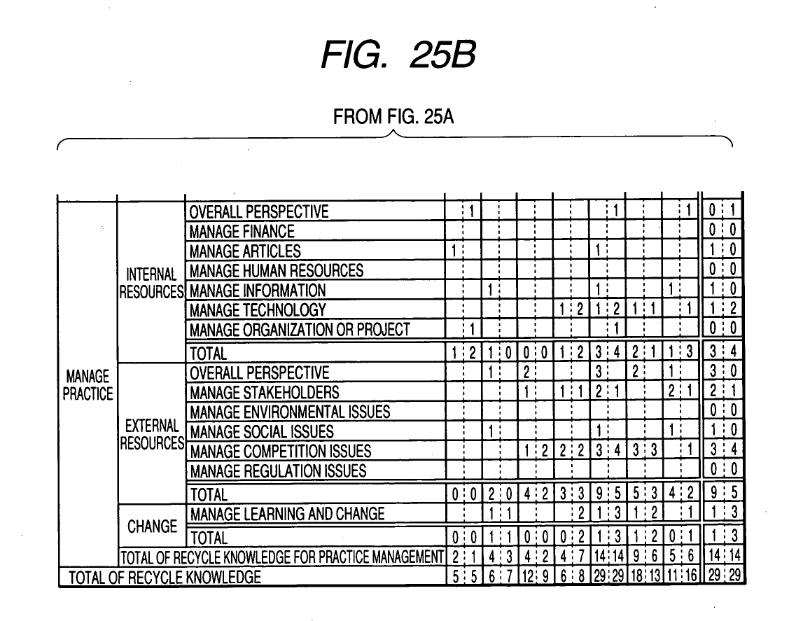

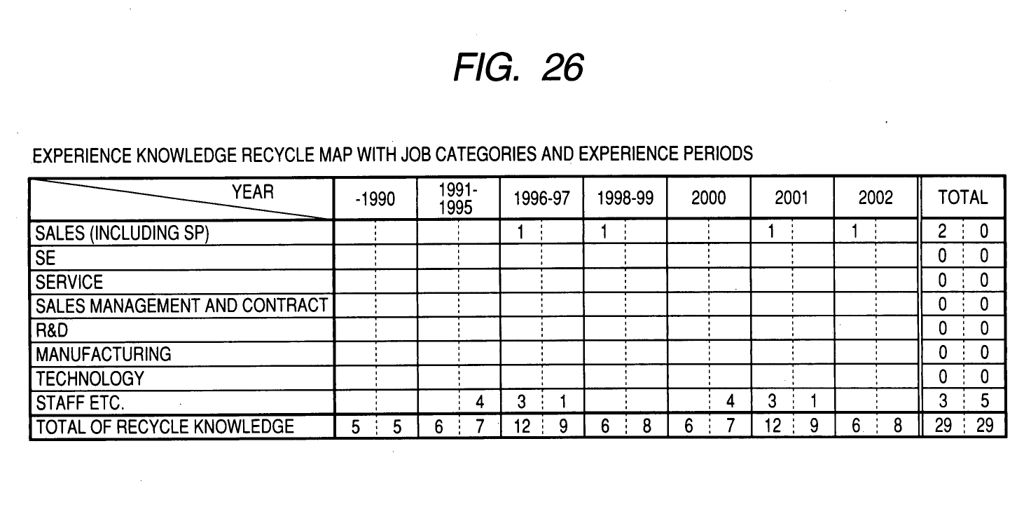

In addition, in the embodiment explained in detail below, a knowledge relation display processing portion 13b configures a functional means to conduct a process of displaying and outputting a propagation state of knowledge shown in FIG. 19, a process of displaying and outputting a propagation velocity of knowledge among individuals shown in FIG. 20, a process of displaying and outputting a total number of pieces of knowledge in a two-dimensional table with activities and knowledge creation processes in columns and rows shown in FIGS. 21 and 22, a process of displaying and outputting a total number of pieces of knowledge in a two-dimensional table with activities and job categories in columns and rows shown in FIG. 23, a process of displaying and outputting a total number of pieces of knowledge in a two-dimensional table with job categories and knowledge creation processes in a two-dimensional table with columns and rows shown in FIG. 24, a process of displaying and outputting a total number of pieces of knowledge with activities and periods of experience in two-dimensional table with columns and rows shown in FIGS. 25 and 26, a process of displaying and outputting a total number of pieces of knowledge in a two-dimensional table with periods of experience and knowledge creation processes in columns and rows, and the like.

In addition, in the embodiment explained in detail below, an experience-knowledge database 12 configures a database of classifying into an activity and knowledge creation process and storing information about an experience and information about knowledge and information about application of knowledge, a database of storing the information analyzed above.

In addition, in the embodiment explained in detail below, a dictionary database 14 configures a dictionary means of registering a word which defines an activity and a knowledge process and being referred by the identifying process above.

Details of processing carried out in the embodiment will be described below.

The web server 10 provides questions of a questionnaire for surveying experiences and knowledge to the client computers 2 so as to display the questions on the client computers 2. The web server 10 receives answers to the questions from users as to past experiences, knowledge acquired from the past experiences, etc., and accumulates the answers from the users into the experience-knowledge database 12.

Next, the experience-knowledge processing portion 13 uses the knowledge analysis portion 13a to analyze the answers accumulated in the experience-knowledge database 12 and to analyze an experience of a certain individual, knowledge acquired from the experience, and a use situation (application) of the knowledge. The experience-knowledge processing portion 13 registers the experience, the knowledge and the use situation in the experience-knowledge database 12. In this event, the experience, the knowledge and the use situation are associated with a relevant business activity using the activity dictionary accumulated in the dictionary database 14, and with a knowledge creation process using the knowledge process dictionary.

In response to an operation made on the input device 6 of the client computer 2 by the user, for example, the knowledge relation display processing portion 13b makes comparison among pieces of knowledge registered in the experience-knowledge database 12, calculates a reuse state or a propagation state of the knowledge, and provides the calculated reuse or propagation state of the knowledge to the client 2. Thus, the reuse state or the propagation state of the knowledge is displayed on the display device 5 of the client 2.

In accordance with a request operation of the user such as a retrieval operation, the knowledge relation display processing portion 13b provides the client 2 with a log stored in the log database 17 and experience-knowledge accumulated in the experience-knowledge database 12. Thus, the log and the experience-knowledge are displayed on the display device 5 of the client 2. For example, knowledge registered in the experience-knowledge database 12 is displayed as a two-dimensional table constituted by business activities and knowledge creation processes, so that the registered experience-knowledge can be looked over. In addition, the knowledge relation display processing portion 13b executes a process for retrieving, of the registered knowledge, one reused by a user in a certain knowledge creation process or one created in a certain business activity together with a case of the knowledge, etc.

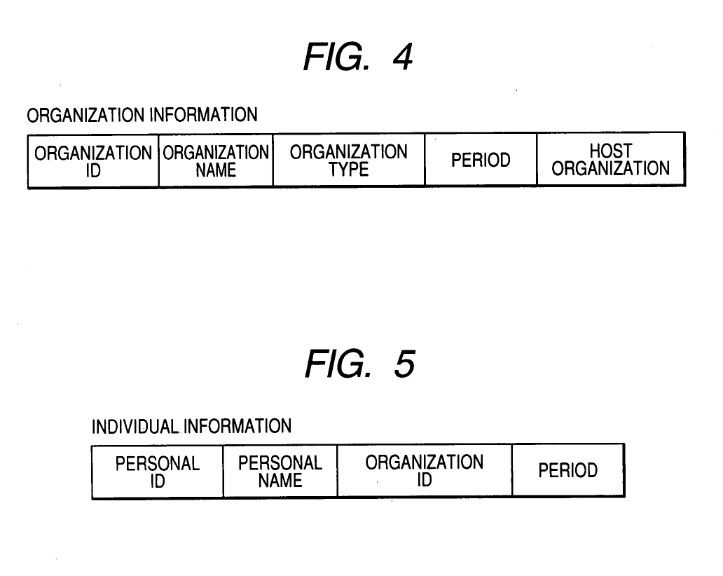

FIG. 4 shows an example of organization information stored in the organization and individual database 15. The organization and individual database 15 stores the organization information including an identifier (organization ID), an organization name, an organization type, organization duration (term of existence), and a host organization ID if the organization has a host organization.

Incidentally, the field of the organization type may be filled with an attribute including not only a formal organization described in an organization chart of an enterprise or a project organization made up of a plurality of formal organizations joined horizontally for achievement of one certain purpose, but also an organization like a community based on spontaneous participation or like an information sharing group with the same interest or concern.

FIG. 5 shows an example of individual information stored in the organization and individual database 15. The organization and individual database 15 stores individual information of each member of each organization, including an identifier (personal ID), an personal name, an organization ID (corresponding to the organization ID in FIG. 4) of the organization the individual belongs to, and a period for which the individual has belonged to the organization.

Incidentally, the individual information may include job position information in the organization such as a manager. The job position information may be also used for specifying a knowledge source of reused knowledge, or the like.

The experience-knowledge processing portion 13 uses such organization information and individual information to specify the role of an organization when there are individual information and organization information in a past experience inputted in the experience-knowledge database 12. The role can be also used for specifying a business activity or a job category. The role can be also used for specifying a knowledge source of reused knowledge, or the like.

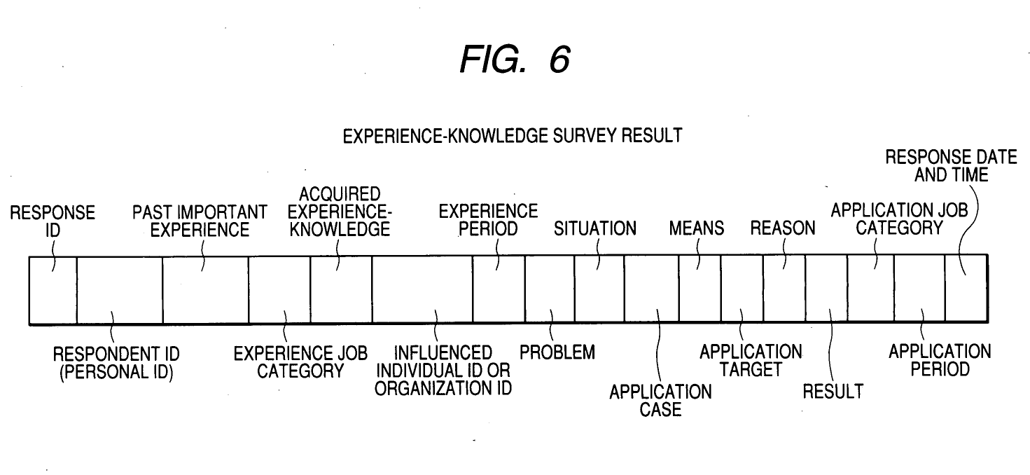

FIG. 6 shows an example of survey result information concerning use of a past experience and knowledge acquired from the experience, which information is stored in the experience-knowledge database 12.

When an survey target (user) answers questions displayed on the web browser operating on the client computer 2 and sends the answers, the data collection unit 11 receives the answers, compiles the answers, creates survey result information shown in FIG. 6 in accordance with the contents of the answers and the contents of the questions, and stores the survey result information in the experience-knowledge database 12.

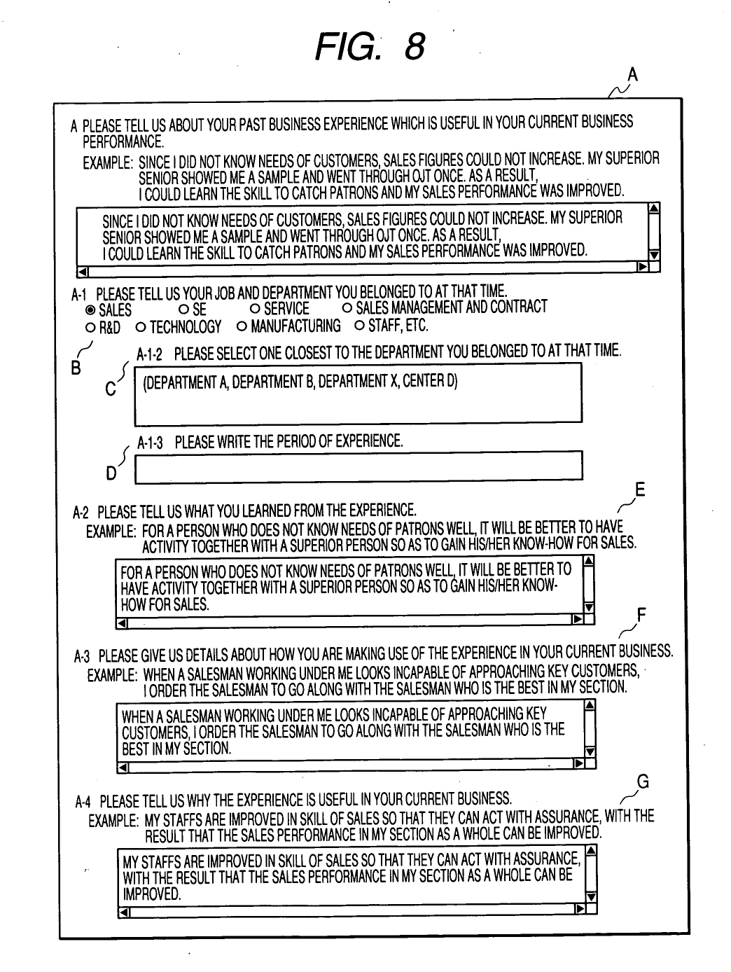

FIG. 8 shows an example of an electronic questionnaire presented to a user of the client 2. The questionnaire is a questionnaire for asking an individual questions in turn about a past experience and knowledge acquired from the experience in the form of a simple story in which the individual applies the knowledge to solve a problem.

For example, as to the content of a past business experience useful in current business performance, the questionnaire includes a question A with the content “Please tell us about your past business experience which is useful in your current business performance.”, and a field allowing the user to describe the experience content in a text in answer to the question A.

The questionnaire further includes a question B about the work content and the job duty at that time, a field allowing the user to select one from choices in answer to the question B, a question C about the content of an organization (that is, correspondence to an existing organization) the individual were belonged to at that time, a field allowing the user to give description in a text in answer to the question C, and a question D about the duration of the gained experience, and a field allowing the user to give description in a text in answer to the question D.

Incidentally, in the case of experience useful in an activity of another person such as a boss or in another department, a question as to who or which organization influenced the experience strongly may be provided additionally.

The aforementioned questions are followed by a question E with the content of “acquired experience-knowledge” such as “what did you learn from the experience?”, a field allowing the user to give description in a text in answer to the question E, a question F with the content of “application of the knowledge” such as “Tell us the situation you make use of the experience.” and a field allowing the user to give description in a text in answer to the question F. Due to the form in which the user answers the questions in such an order, the respondent user tells a simple story along a knowledge flow of the user's own past experience, acquired knowledge and application of the knowledge in connection with the user's personal solution to a problem. The result is stored in the experience-knowledge database 12.

Incidentally, a question G about the reason or ground why the experience or the knowledge is useful in current business and a field allowing the user to give description in a text in answer to the question G are included in this embodiment.

The knowledge analysis portion 13a of the experience-knowledge processing portion associates answers by the user (survey target) to the questions with the individual information and the organization information (FIGS. 4 and 5) stored in the organization and individual database 15 so as to create survey result information in the configuration shown in FIG. 6. The created survey result information includes description of a past important experience, a job category at that time (experience job category), an influencer/organization identifier (personal ID or organization ID), an experience period, a problem, a situation, an application case, a reason, a result, an application job category, an application period, response date and time, etc. which are all extracted from the answers, as well as an identifier (respondent ID, corresponding to the personal ID in FIG. 5) used for identifying the respondent user, and an identifier (response ID) for identifying the answers. The created survey result information is stored in the experience-knowledge database 12.

Incidentally, the survey result is added to the answers about acquired experience-knowledge and application of the knowledge, and stored in the experience-knowledge database.

For example, as to the information of an individual or an organization giving an influence to the respondent, the respondent himself/herself may answer such information directly. Alternatively, for example, the knowledge analysis portion 13a may automatically obtain such information by performing text analysis on sentences contained in the answers from the respondent in the same manner as on the other text-inputted answers. The experience job category may be automatically obtained by retrieval from the organization and individual database 15 based on the personal ID and the experience period of the respondent. As for the application job category, a similar process may be carried out. When information related to date and time is included in the ground or result of the answers of the user as a survey target, the date and time information may be registered as the application period. When such date and time information is not included, date and time of response may be regarded as the date and time of application of experience-knowledge to a business activity at the time of the survey so that the date and time of response may be set as the application period.

As shown in FIG. 6, the date and time of response of the user as a survey target may be added to the survey result so as to be registered in the experience-knowledge database 12. When the date and time of response is registered additionally, comparison with a past survey result can be made so as to make it possible to calculate a change in consciousness of personal useful knowledge or the like, propagation of useful experience of one individual to another individual, and coincidence in activity content or influencer data. In addition, when such a questionnaire survey is conducted regularly, e.g. annually, the propagation velocity of experience-knowledge into one certain organization or to relevant members of another department can be calculated.

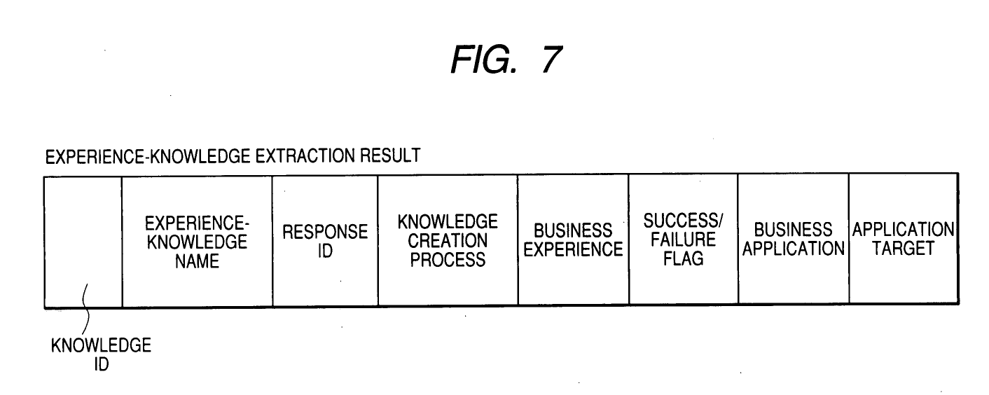

FIG. 7 shows an example of an extraction result of experience-knowledge (knowledge acquired from an experience) which is obtained by analyzing and processing the questionnaire survey result by use of the knowledge analysis portion 13a executing an analysis program and which is registered in the experience-knowledge database 12.

The experience-knowledge includes an identifier (knowledge ID), an experience-knowledge name (title), a response identifier (response ID) of the user as a survey target, a knowledge creation process (step of SECI process), a business activity (business experience) where the useful experience was gained, a success/failure flag, a success/failure flag, an applicable business activity (business application), and an application target.

Incidentally, for each of the business experience and the business application, a business activity ID corresponding thereto is registered. In addition, a result obtained by summarizing experience-knowledge read from the answers of the user as a survey target by use of an existing summarization technique maybe registered as the title, or the person in charge of knowledge management system may register and edit the title.

Here, for an application target, for example, from a response: “When a salesman working under you looks incapable of approaching key customers”, a word: “a salesman under you” is registered as an application target. A success/failure flag is a flag representing a success or an example which he could not experience until then, or a failure or an example giving an unfavorable result. In the following example, it is explained that the flag is “1” when he experiences a success or an example which he could not experience until then, and is “−1” when he experiences a failure or an example giving an unfavorable result. For example, from a response: “Since I did not know needs of patrons, sales figures could not increase. I asked my superior senior to show a sample”, a success flag is registered by “1” as information representing a past important successful experience in the experience-knowledge database, since it is an experience that a superior senior showed as a sample an action to grasp customers' needs that he could not find.

Thus, based on the answers from the user as a survey target, including information about a personal experience, information about knowledge acquired from the experience, information about application of the knowledge, information about a period of the experience or the application, information for identifying an individual, etc., the knowledge analysis portion 13a performs an analysis process and an association process so as to obtain a knowledge extraction result shown in FIG. 7. The knowledge analysis portion 13a stores the knowledge extraction result in the experience-knowledge database 12 while associating the knowledge extraction result with the organization information shown in FIG. 4, the personal information shown in FIG. 5 and the survey result shown in FIG. 6. Accordingly, inputted information about an experience-knowledge, application, etc. is managed in association with an activity, a knowledge creation process, a job category, a period of the experience or the application, etc.

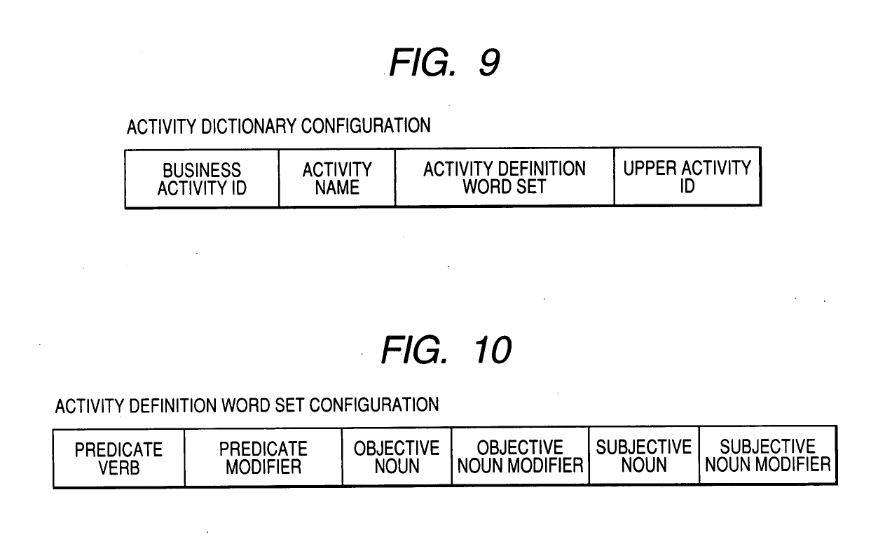

FIG. 9 shows a configuration of an activity dictionary stored in the dictionary database 14 by way of example.

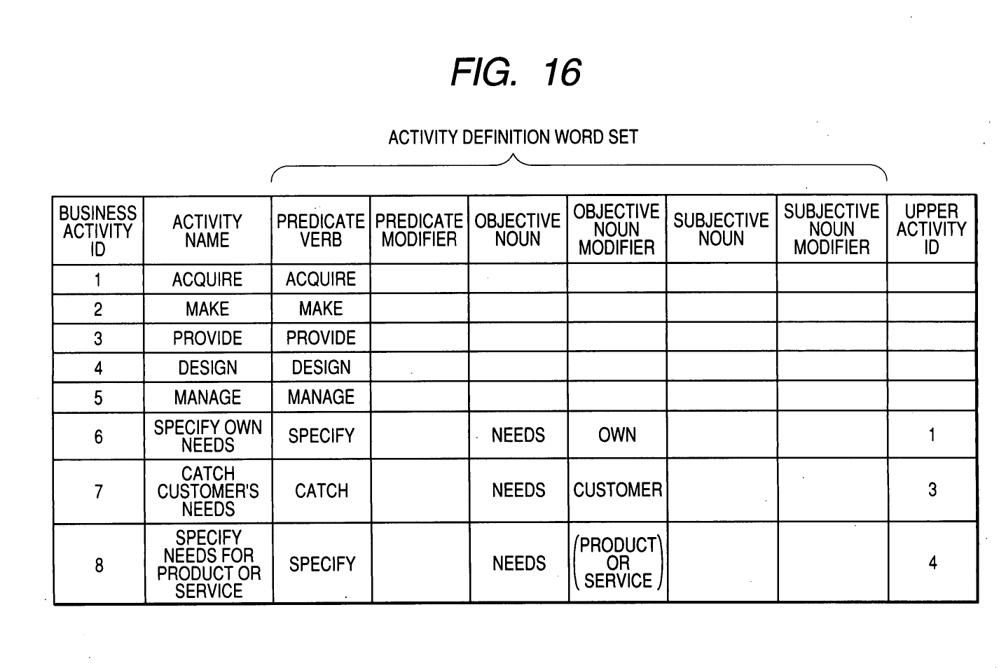

A business activity described in the activity dictionary includes a business activity ID, an activity name, an activity definition word set, and an upper activity ID. The activity definition word set includes a predicate verb, a predicate modifier, an objective noun, an objective noun modifier, a subjective noun, and a subjective noun modifier as shown in FIG. 10. These words are used for specifying an activity. For example, as shown in FIG. 16, for an activity name “acquire customer's needs”, “acquire”, “needs” and “customer's” are registered in the predicate verb, the objective noun and the objective modifier respectively. In addition, for a description in terms of a business activity such as “servicemen keep good relationship with customers”, “keep”, “good”, “relationship”, “with customers” and “servicemen” are registered in the predicate verb, the predicate modifier, the objective noun, the objective noun modifier and the subjective noun respectively.

Incidentally, when the predicate modifier, the objective noun, the objective noun modifier, the subjective noun and the subjective noun modifier are not required, data do not have to be registered. When there are a plurality of candidates for the objective noun or the like, the candidates may be registered in a logical expression such as (A or B) or (A and B).

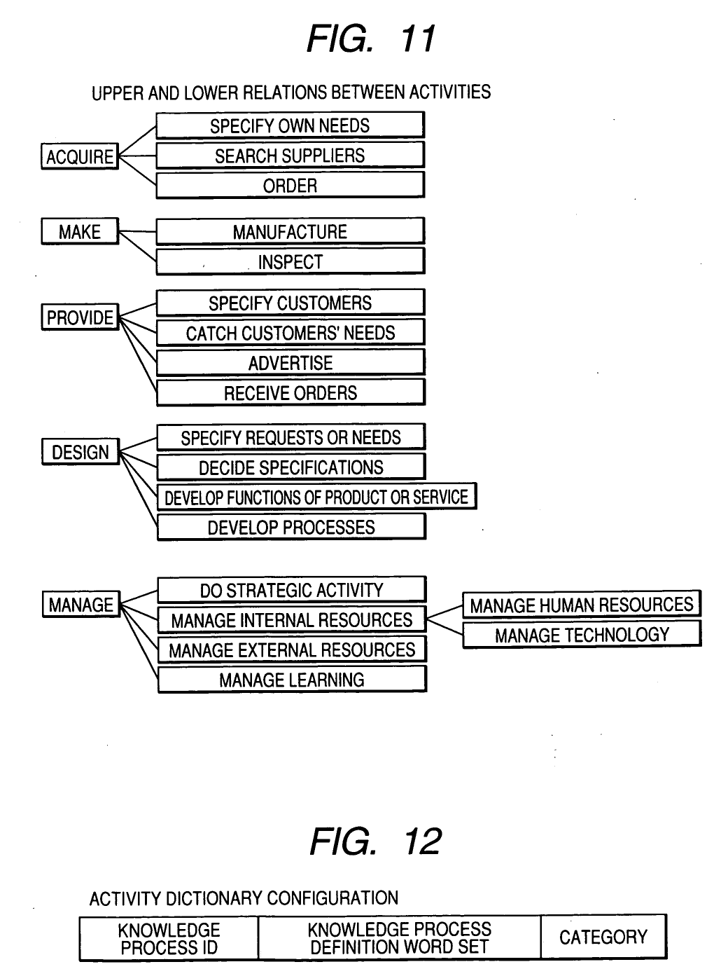

FIG. 11 shows an example of upper and lower relations in activity categories used in this embodiment in a tree structure.

In the activity categories, “acquire”, “make”, and “provide” correspond to business activities directly related to a value chain of a business activity “acquire a value source such as a material” (input), a business activity “make a value” (process), and a business activity “provide the value” (output) respectively. “Design” corresponds to a business activity for designing the value, and “manage” corresponds to a business activity for managing the aforementioned four business activities. For example, FIG. 11 shows that an activity “catch customer's needs” has an upper activity “provide”, and an activity “manage human resources” has an upper activity “manage internal resources”, which further has an upper activity “manage”.

FIG. 12 shows an example of a knowledge process dictionary accumulated in the dictionary database 14. Each knowledge creation process described in the knowledge process dictionary includes a knowledge process ID, a knowledge process definition word set, and a category.

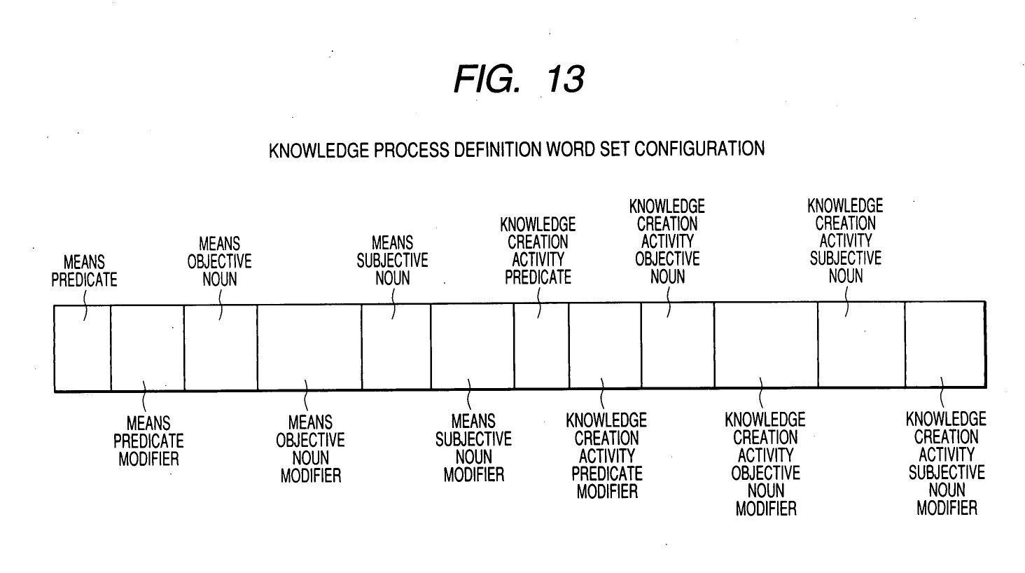

As shown in FIG. 13, the knowledge process definition word set is made up of a combination of an activity word set expressing means and a word set expressing a knowledge creation process. A combination of words registered in each activity word set is similar to that in the activity definition word set.

Specifically, the knowledge process definition word set includes a means predicate, a means predicate modifier, a means objective noun, a means objective modifier, a means subjective noun, a means subjective modifier, a knowledge creation activity predicate, a knowledge creation activity predicate modifier, a knowledge creation activity objective noun, a knowledge creation activity objective noun modifier, a knowledge creation activity subjective noun, and a knowledge creation activity subjective modifier.

In the same manner as the activity definition word set, items other than the knowledge creation activity predicate do not have to be registered when they are not required. In the same manner as the activity definition word set, the knowledge process definition word set may be expressed logically.

For example, in the case of a knowledge creation process “get an idea from a dialogue with a fellow worker” concerning socialization (S) in an SECI model, “socialization” is registered in the field “category” in the knowledge process dictionary, and “dialogue”, “fellow worker”, “get” and “idea” are registered as the means predicate, the means predicate modifier, the knowledge creation activity predicate, and the knowledge creation activity objective noun respectively in the knowledge process definition word set.

In addition, in the dictionary database 14, an ordinary dictionary expressing the relation of a word with its synonym or narrow-sense word, such as a thesaurus, is registered. Further, proper nouns expressing names of customers' or suppliers' enterprises or departments, and in-house terms may be registered as a dictionary in accordance with each occupational category or organization.

Next, a process carried out by the experience-knowledge processing portion 13 of the server 1 will be described.

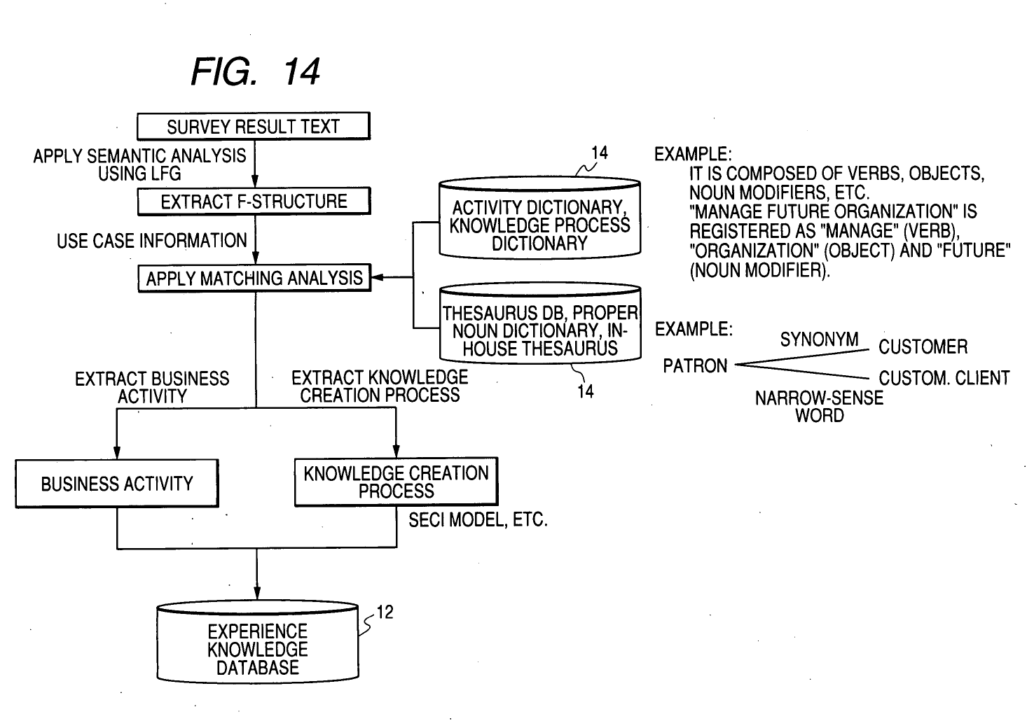

FIG. 14 shows an outline of the process for extracting a business activity or a knowledge creation process by the knowledge analysis portion 13a from a text described in the survey result (FIG. 6) registered in the experience-knowledge database 12.

First, the described text is parsed so that verbal, nominal, adjective and adverb words, phrases and clauses are extracted. Preferably, information about a predicate, an object, a modifier, etc., is further obtained by semantic analysis with the result that a structure such as a parse tree including a semantic structure can be extracted. FIG. 14 shows an example of the analysis process where semantic analysis is performed using Lexical Functional Grammar (LFG).

Response result is divided into each item in survey result table in the experiment knowledge data base 12, using the division rule. Then, case information and word class information obtained as an analysis result are matched with an ordinary dictionary and a dedicated dictionary registered in the dictionary database 14. In this embodiment, an activity dictionary is used as the dedicated dictionary when a business activity is to be extracted, while a knowledge process dictionary is used as the dedicated dictionary when a knowledge creation process is to be extracted.

A corresponding business activity (activity ID) and a corresponding knowledge creation process (knowledge process ID) are extracted so that knowledge acquired from experience (experience-knowledge) composed of business experience, business application and a knowledge creation process is registered in the experience-knowledge database 12. Incidentally, when only sentence structure analysis is used, the matching process may be carried out based on a co-occurrence relation between words.

That is, the business activity and the knowledge creation process corresponding to the experience-knowledge obtained from the answers to the questions are extracted by the aforementioned process and registered in the experience-knowledge database 12 while being associated with the experience-knowledge.

Such a process for carrying out extraction, registration, etc. will be described below in more detail.

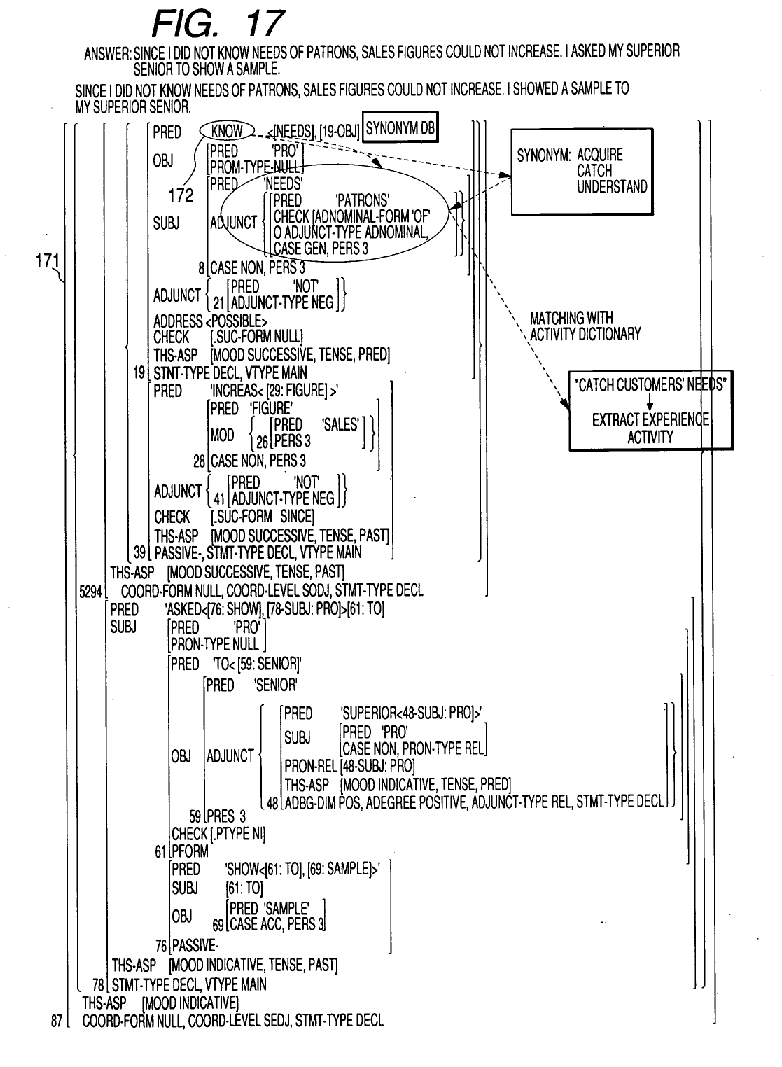

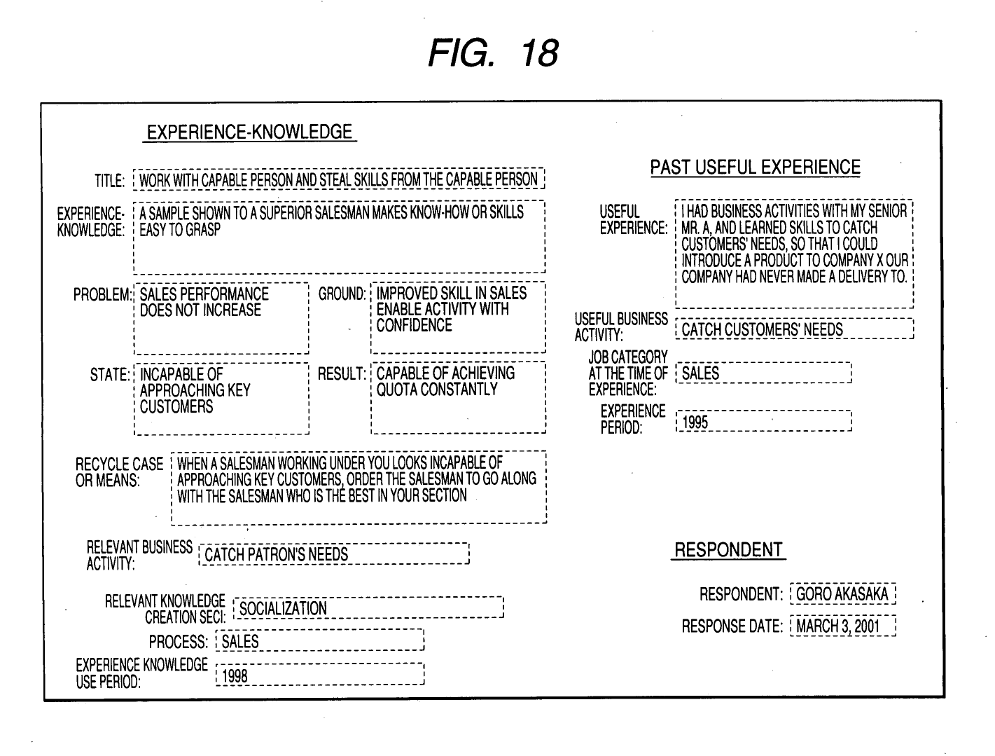

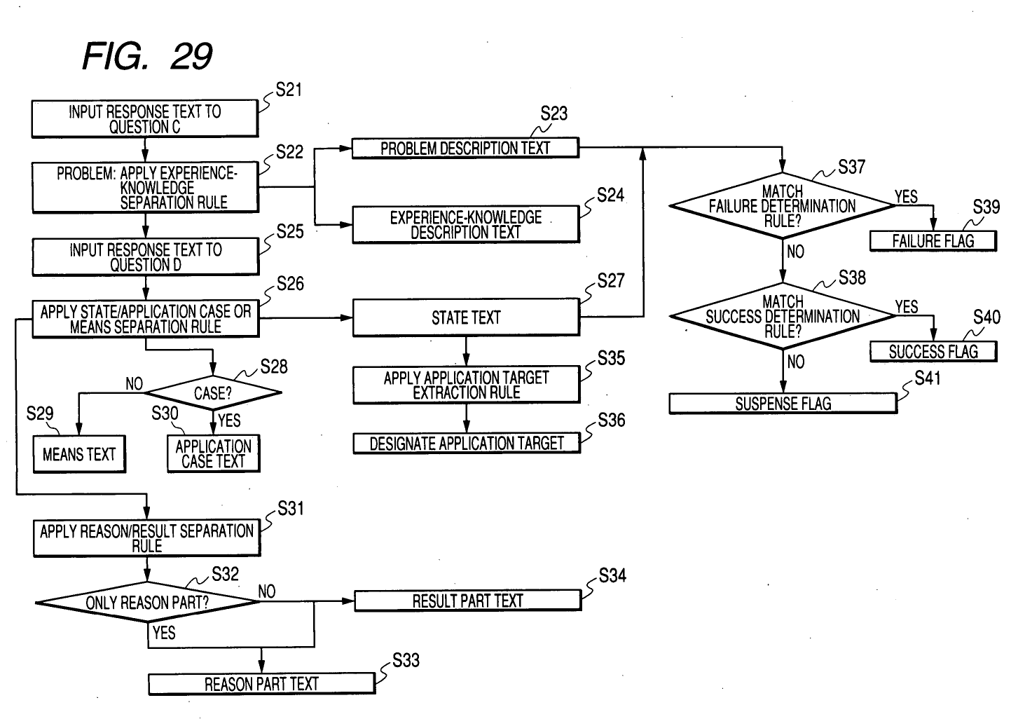

At first, referring to a process flowchart shown in FIG. 29 and a case shown in FIG. 17, a method of extracting each item in the survey result table in the experience-knowledge database 12 (division process) by text-processing the questionnaire response text using the rule and by separating states, application cases and the like is explained in detail.

[Separation of Problem and Experience-Knowledge]

Using the problem/experience-knowledge separation rule, descriptions of problem and experience-knowledge are separated from the inputted questionnaire response text (response text to the question A-2 in FIG. 8: “For a person who does not know needs of patrons well, it will be better to have activity together than a superior person so as to gain his/her know-how for sales”, Step S21, S22). Then, a text describing a problem and a text describing experience-knowledge are extracted (Step S23, S24). For example, FIG. 17 briefly shows an application process of the rule designating to “experience-knowledge” item in the experience-knowledge database, since the following description contains an adjective “better”, designating description preceding conjunctive word: “case”, “when” or “therefore” contained in the text to the “problem” item in the experience-knowledge database 12.

Similarly, using the state/application case or means separation rule, a description of state and a description of application case or means are separated from the questionnaire response text (response text to the question A-3 in FIG. 8: “When a salesman working under me looks incapable of approaching key customers, I order the salesman to go along with the salesman who is the best in my section”, Step S25, S26). An item of “application case or means” and “application case flag” in the experience-knowledge database 12 are designated (Step S27 to S30). Applied the separating rule of state and application case or means in the example of FIG. 17, when conjunction such as “therefore”, “since” or “as” is contained, a description before the conjunction is designated to the “state” item in the experience-knowledge database. When a predicate verb contained in a description after the conjunction is a past form, a case is determined to be described, the description after the conjunction is designated to an “application case” in the experience-knowledge database. When the predicate verb is not a past form, a means is determined to be described, and is designated to a “means” in the experience-knowledge database.

[Separation of Basis and Result]

Similarly, using the reason/result separation rule (Step S31), descriptions of reason and result are separated from the questionnaire response text (Step S32 to S34). FIG. 17 briefly shows a process that when a conjunction such as “therefore”, “as” or “since” is contained, a description before the conjunction and a description after the conjunction are designated to the “reason” and “result” items in the experience-knowledge database 12, respectively. When the response text ends with a description of “since” or the like, as an analysis result of the questionnaire response text ends with a predicate of the highest level, not a verb, a rule is described to designate only the “reason” in the experience-knowledge database.

[Extraction of Application Target]

For a state description text extracted (Step S27) using a rule of extracting an application target (Step S35), a participant (application target) is extracted from the “state” item in the experience-knowledge database 12 designated before. FIG. 17 describes a determination rule of coincidence with words representing a hierarchical relation in a job category, a role, or an organization. As a word “working under you” is contained in these words, “working under you” is extracted, and is designated to an “application target” in the experience-knowledge database.

[Extraction of Success/Failure Flag]

From the questionnaire response text a possible expression, positive/negative expression, or a specific verb is extracted, based on a failure determination rule or a success determination rule (Step S37, S38), success or failure is determined and a success/failure flag is designated (Step S39, S40). For example, a rule is described in advance that when a predicate verb contains possible and negative expressions such as “cannot do” or “cannot do well”, it is determined to be “failure”. Similarly, another rule is described in advance that when it contains possible and positive expressions, it is determined to be “success”. Incidentally, when it cannot be determined whether success or failure, it remains suspend (Step S41). Incidentally, a semantic expression representing “situation continues”, such as “has been ______” may be extracted and appended to the rule.

[Extraction of Business Activity]

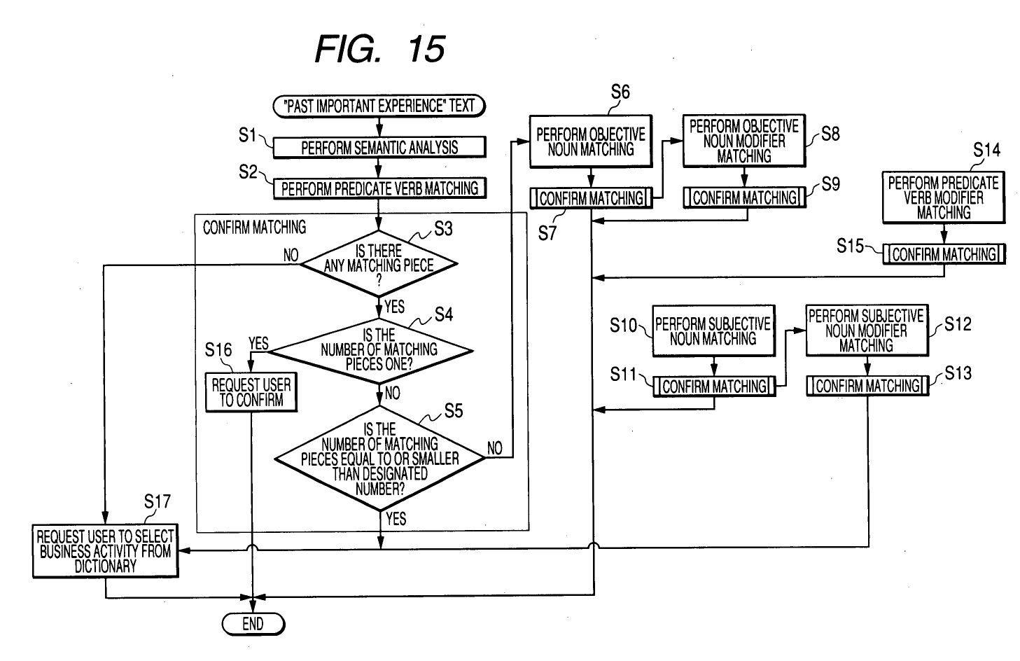

A process for extracting a business experience activity from the text described as “past important experience” in the survey result (FIG. 6) will be described in detail with reference to FIGS. 15 to 17.

First, semantic analysis based on the Lexical Functional Grammar is carried out (Step S1) so as to obtain an analysis result 171 in which predicates, subjects, modifiers, etc. are presented as shown in FIG. 17. It is judged whether a predicate verb 172 coincident with or similar to a verb in the f-structure expressing the analysis result has been registered in the activity definition word set of the activity dictionary or not (Step S2).

That is, a judgment is made as to whether the verb in the f-structure matches with a predicate verb or not (Step S3). When the verb matches, it is judged whether the number of matching predicate verbs is one or not (Step S4). When the number is one, the matching predicate verb is presented to the client user or the administrator user so as to be confirmed thereby. Then, the process is terminated (Step S14). On the contrary, when the number of matching predicate verbs is larger than a number designated by system setting or user setting (Step S5), a matching process based on an objective noun, etc. is further carried out. On the other hand, when the number of matching predicate verbs is not larger than the designated number (Step S5), or when matching predicate verbs are absent so that no business activity can be identified (Step S3), the client user or administrator user is requested to select a business activity from the dictionary (Step S17).

Here, when there are detected a plurality of business activities (Step S5), a coincident or similar objective noun detecting/matching process (Steps S6 and S7), a coincident or similar objective noun modifier detecting/matching process (Steps S8 and S9), a coincident or similar subjective noun detecting/matching process (Steps S10 and S11), a coincident or similar subjective noun modifier detecting/matching process (Steps S12 and S13), and a coincident or similar predicate modifier detecting/matching process (Steps S14 and S15) are carried out until a single business activity or business activities whose selection number is not larger than the designated number are identified. Incidentally, the matching confirmation process (in each of Steps S7, S9, S11, S13, and S15) is the same as the process in each of Steps S3 to S5 and Step S16.

Incidentally, in the above identifying process the matching process may be carried out by defining rephrase rules in paragraph unit in the dictionary database in advance, and including rephrase expressions which have the same meaning. For example, when the response text has a phrase: “noun B of noun A is verb C”, and a activity expression phrase is “objective modifier: noun A, objective noun: B, and predicate verb: C′”, it can be determined whether they are synonymous or not by defining and applying a paragraph synonymous rule, a verb phrase synonymous rule and noun phrase synonymous rule.

Incidentally, a passive voice may be used in the inputted text. In such a case, the relation in the paragraph synonymous rule between the subject and the object is reverse. It is therefore preferable that the matching processes with respect to the objective noun, the objective noun modifier, the subjective noun and the subjective noun modifier are defined to be carried out on both the objective noun and the subjective noun, that is, both the noun regarded as an object and the noun regarded as a subject in the result of semantic analysis.

When a plurality of business activities are selected, the user may be allowed to select suitable one of the business activities.

Further, even when a single business activity is detected, a query as to whether the business activity is correct or not may be issued to the user (Step S16). When it is not correct, the routine of process returns to a step previous to the step where the single activity was identified. Thus, a closest business activity can be selected from a plurality of business activity candidates lined up in the previous step.

Incidentally, similarity is detected using a thesaurus or the like, based on whether a synonym is included in the thesaurus or not. No business activity may be identified in spite of this process. In such a case, the same process is carried out on an upper or lower business activity.

When a business activity cannot be identified finally, the user may be requested to register a new business activity. In this case, it is preferable that, of business activities registered in the business activity dictionary, ones (fundamental business activities) having no upper activity registered are presented to the user by means of a menu or the like so that the user can select a relevant business activity from the presented business activities and give detailed description to the selected business activity (Step S17).

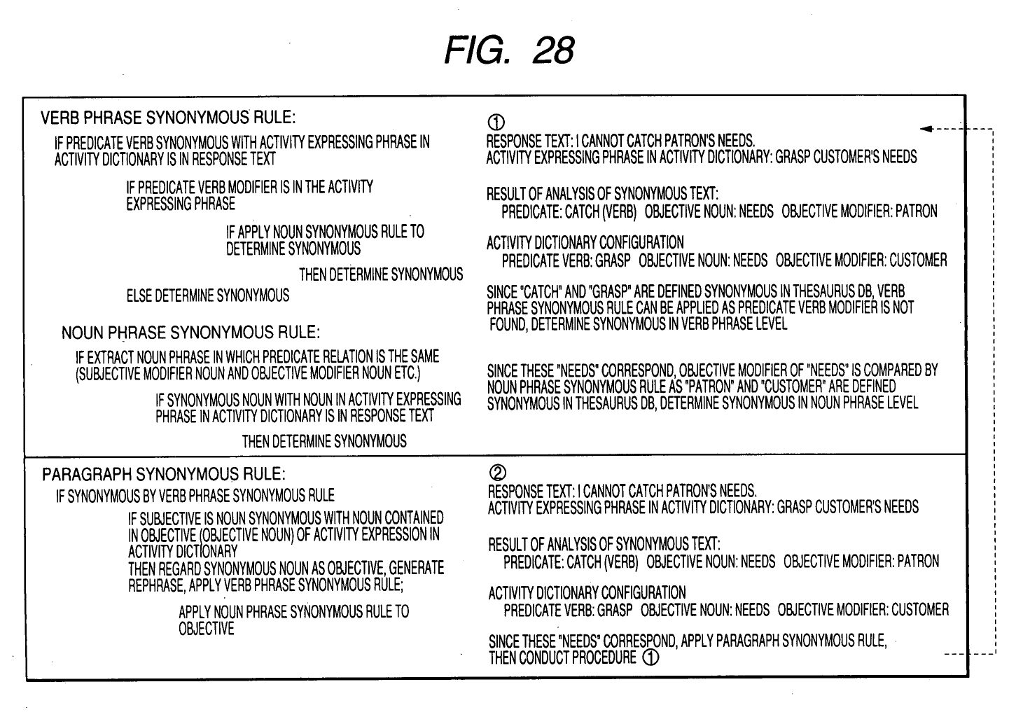

Description will be given to the case where a business activity is extracted from a text description about an experience activity “Since I did not know needs of patrons, sales figures could not increase. My superior senior showed me a sample .” as shown in the example of FIG. 17 using rules shown in FIG. 28.

From the analysis result, first, verbs (predicates) “know”, “increase” and “show” are extracted as predicate verb candidates. Synonyms “acquire”, “understand” and “catch” are obtained by use of a thesaurus of the general dictionary.

Matching with the activity dictionary shown in FIG. 16 by way of example is carried out so that business activities ID-1, ID-7 and ID-8 each having “catch” or “acquire” as its predicate verb are obtained as business activity candidates (applied with the verb phrase synonymous rule).

Next, applied with the paragraph synonymous rule, a matching process is carried out on objective nouns in a utilization dictionary and subjective nouns in an analysis result. A subject (subjective noun) of the analysis result is coincident with objective nouns of the business activities ID-7 and ID-8. The business activities ID-7 and ID-8 are left as the business activity candidates because their objective nouns are both “needs”.

Next, a matching process is applied to a modifier “patron” of the subject as the analysis result using the noun phrase synonymous rule. Assume that “customer”, “custom” and “client” are registered as synonyms of “patron” in the thesaurus as shown in FIG. 14. When the matching process is carried out on objective noun modifiers, an objective noun modifier “customer” of the business activity ID-7 can be matched.

In this manner, a business activity “catch customers' needs” of the business activity ID-7 can be extracted automatically. This business activity “catch customers' needs” is set in the item “business experience” in the experience-knowledge extraction result shown in FIG. 7.

Since the activity “catch customers' needs” is a lower activity of a business activity “provide” in a fundamental business category “provide a value” as shown in FIG. 11, the activity means that knowledge about the fundamental business category “provide a value” has been acquired. As shown in FIG. 7, the knowledge is registered in the experience-knowledge database 12 while being associated with the business activity.

Incidentally, business application of the experience-knowledge extraction result can be extracted from an application case of the experience-knowledge survey result or the like. Since the business application is extracted in the same process as described above, description thereof will be omitted.

[Extraction of Knowledge Creation Process]

Description will be given to the case in which a process for extracting a knowledge creation process from the experience-knowledge and the application content registered in the survey result shown in FIG. 6 is carried out by the knowledge analysis portion 13a.

First, sentence structure analysis is carried out in the same manner as that for extracting the business activity, so as to extract vocabularies such as verb, noun, adjective, adverb, etc.

Here, further, a rule for separating a sentence into a means/behavior (activity) descriptive part and a knowledge creation process descriptive part (knowledge creation activity/mean activity separation rule) may be registered so that a sentence using conjunctional words such as “through”, “by”, “when”, etc. is separated into the means/behavior descriptive part and the knowledge creation process descriptive part.

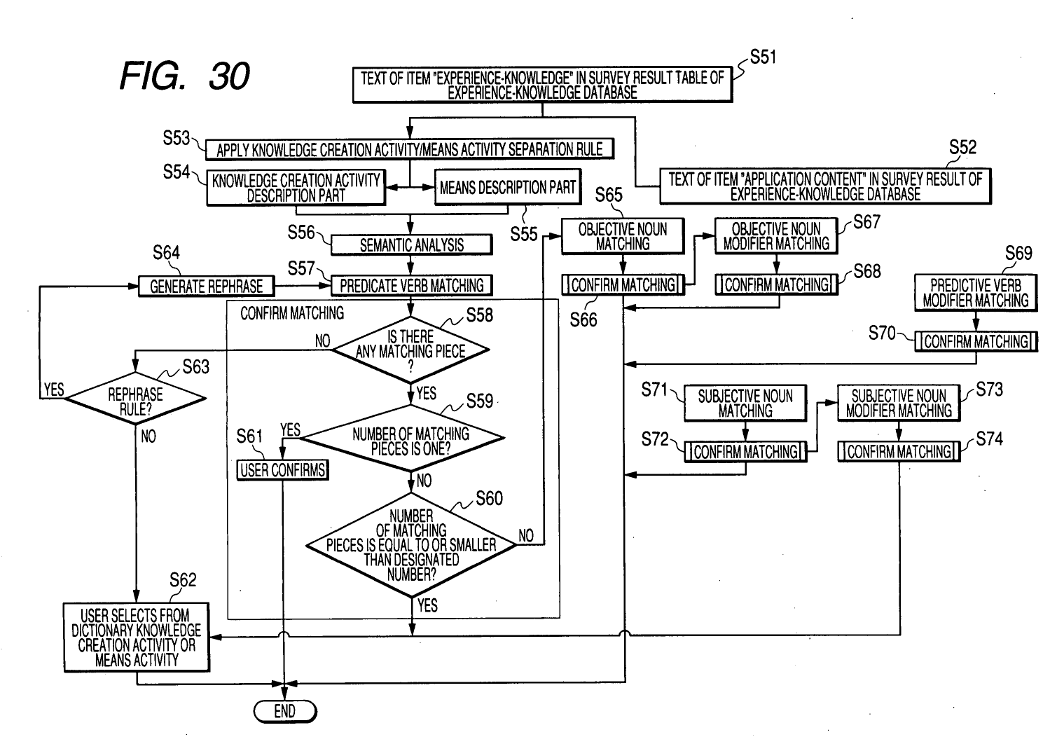

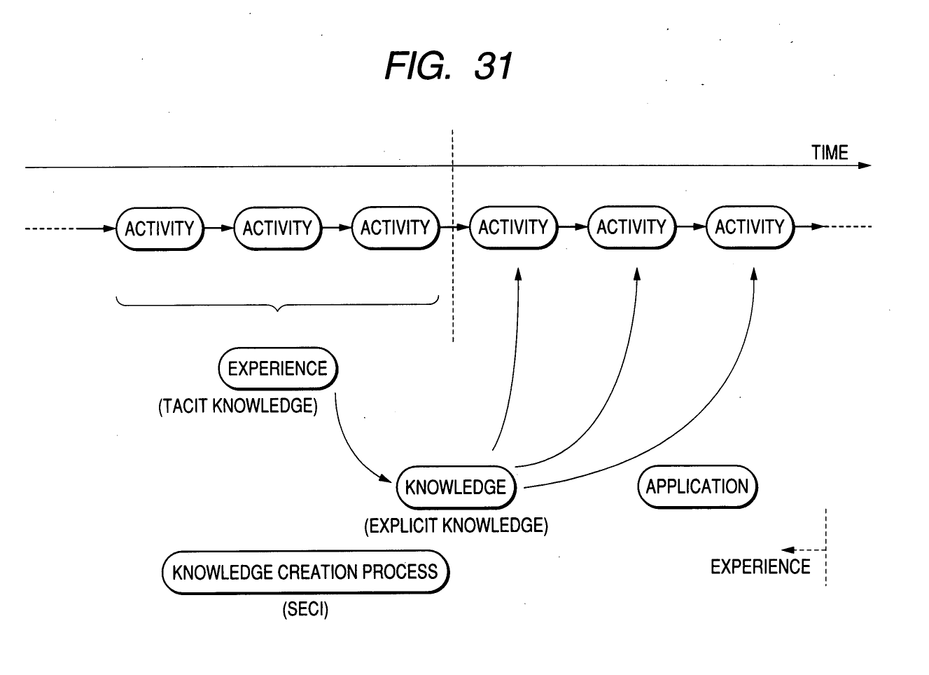

As shown in the flowchart of extracting the knowledge creation process in FIG. 30, similar to the case of extracting business activities, it is preferable that from a text in “experience-knowledge” and “application content” items in the experience-knowledge database 12 (Step S51, S52), applying with the knowledge creation activity/means activity separation rule (Step S53), a descriptive part of the knowledge creation activity and descriptive part of means are extracted (Step S54, S55), semantic analysis is carried out (Step S56), information about predicates, objectives, modifiers and the like are analyzed, and a parse tree containing a semantic structure is configured. Then, it is detected that is coincident with or similar to a predicate verb in the parse tree and a knowledge creation activity predicate in the knowledge process dictionary (Step S57 to S60), and when the matching number is one, they are displayed on the screen and confirmed by a user, then the process ends (Step S61).

This detection is carried out by a matching process. When the matching number is zero (Step S58), if a rephrase rule is applicable, rephrase of predicate verb is generated applied with the rephrase rule and a process is carried out (Step S63, S64), on the other hand, if the rephrase rule is not applicable, a user is urged to select items of knowledge creation activity/means activity in the dictionary, then the process ends (Step S62).

In addition, when the matching number is larger than the one the user designates (plural knowledge creation predicates are detected, Step S58), as well as detecting means predicates which are coincident with or similar to and processing specifying business activities below, for knowledge creation predicates and means predicates, a process of matching objective nouns which are coincident with or similar to (Step S65, S66), a process of matching objective noun modifier (Step S67, S68), a process of matching predicate verb modifier (Step S69, S70), a process of matching of subjective noun (Step S71, S72), and a process of matching of subjective noun modifier (Step S73, S74) are carried out until a single knowledge creation process is identified.

When different knowledge creation processes are identified from a text describing experience-knowledge (e.g. answer part E in FIG. 8), a text describing past important experience (e.g. answer part A in FIG. 8) and a text describing application content (e.g. answer part F in FIG. 8), the user may be allowed to select the most suitable one of the knowledge creation processes. When no knowledge creation process can be identified from the text describing experience-knowledge shown in FIG. 9, the text describing experience, the text describing application content, the user may be requested to select one of the categories registered in the database of the knowledge process dictionary so as to register a new knowledge creation process.

[Experience-Knowledge Registration Process]

Description will be given to the case in which a process for registering an experience-knowledge extraction result with a configuration shown in FIG. 7 in the experience-knowledge database 12 is carried out by the knowledge analysis portion 13a.

A response ID of the survey result and a corresponding response (response ID) of the survey result are registered in the experience-knowledge database 12. A business activity extracted from an inputted item of the answer concerning activity content is registered as business experience, and a business activity extracted from an inputted item of the answer concerning application content is registered as business application. The extraction result of the knowledge creation process is registered as knowledge creation process. Preferably, experience-knowledge read from the answer of the survey target is summarized by an existing summarization technique and the summarized result is registered as experience-knowledge name. Alternatively, a person in charge of knowledge management may register and edit the experience-knowledge name.

As described above, each piece of experience-knowledge of individuals extracted from a questionnaire result about an experience and associated with a business experience activity or a knowledge creation process is registered in the experience-knowledge database 12. The experience-knowledge is displayed on the screen of the display device 5 of the client 2 or the server 1 by the knowledge relation display processing portion 13b as shown in FIG. 18.

That is, information including respondent name, response date and time, experience-knowledge title (experience-knowledge name), experience-knowledge content description (acquired experience-knowledge), problem description, ground description (reason), situation description, result description, recycle case description (application case), relevant business activity description (business experience), relevant knowledge creation process description (knowledge creation process), target job category description, experience-knowledge use period (application period), useful experience description (past important experience), job category at the time of experience (experience job category), experience period, etc. is presented on the screen based on the information shown in FIGS. 4 and 5 and including the experience-knowledge result shown in FIG. 7.

[Calculation of Experience-Knowledge Propagation]

An algorithm for calculating a path (experience-knowledge propagation path) in which experience-knowledge is propagated from one individual to other individuals will be described with reference to FIG. 19. The calculation is performed by the knowledge analysis portion 13a.

First, anyone of experience-knowledge extraction results 1 and any one of experience-knowledge extraction results 2 registered in the experience-knowledge database 12 are extracted. Individual IDs of survey target users giving answers about experience-knowledge are calculated from respondent IDs. The following description will be made on the assumption that a survey target user giving an answer about experience-knowledge 1 is an individual 1 and a survey target user giving an answer about experience-knowledge 2 is an individual 2.

When the individual IDs of the individuals 1 and 2 do not agree with each other, pieces of knowledge creation process information (knowledge process ID) registered in the respective experience-knowledge extraction results are compared with each other. When these knowledge process IDs agree with each other, it is concluded that similar experience-knowledge has been acquired.

Incidentally, detection maybe further made as to whether details of pieces of experience-knowledge agree with each other or not. In this case, texts described as experience-knowledge information registered in experience-knowledge survey results based on response IDs are analyzed semantically by an existing technique so as to form semantic trees. Similarity between the semantic trees is calculated by an existing technique so that coincidence between the two pieces of experience-knowledge is judged from the similarity between the semantic trees.

Influencer information registered as the experience-knowledge survey results is retrieved based on the response IDs registered in the experience-knowledge 1 and the experience-knowledge 2 so as to calculate whether the individual 1 is an influencer of the individual 2 or the individual 2 is an influencer of the individual 1.

When one of the two survey respondents giving answers about their experience-knowledge is an influencer of the other as to the experience-knowledge, it is estimated that the experience-knowledge of the former has been propagated. Then, experience-knowledge propagation data is made up of the experience-knowledge 1, the experience-knowledge 2 and a propagation period. For example, when the individual 1 is an influencer of the individual 2 as to the experience-knowledge acquired by the individual 2, experience-knowledge propagation data (experience-knowledge 1, experience-knowledge 2, two years) is created. This information means that 2 years had passed till the experience-knowledge 1 of the individual 1 was propagated to the experience-knowledge 2 of the individual 2. Incidentally, the value of the propagation period is obtained by calculating a difference between pieces of experience period information respectively registered in an extraction result of the experience-knowledge 1 and a survey result of the experience-knowledge 2 (FIG. 6).

In addition, the organization and individual database 15 is retrieved to compare organization IDs and registered period information. Thus, it is judged whether the survey target users have been in the same department for a fixed period or not. Calculation is made as to whether the period (same organization period) for which the both have been in the same department agrees with experience period information of one of the users (condition 1) and whether experience period information of experience-knowledge of the other user is earlier than the aforementioned same organization period (condition 2). When the conditions 1 and 2 are satisfied, the experience-knowledge is regarded as propagated.

An order list (experience-knowledge propagation list) is created based on the context of the experience period information registered in the experience-knowledge survey results. In the order list, the experience-knowledge 1 and the experience-knowledge 2 are paired. For example, when the experience-knowledge of the individual 1 was acquired earlier than the same organization period and the experience-knowledge of the individual 2 was acquired in the same organization period, experience-knowledge propagation data (experience-knowledge 1, experience-knowledge 2, 5 months) is generated.

[Calculation of Experience-Knowledge Propagation Path and Propagation Velocity]

The knowledge relation display processing portion 13b connects pieces of the aforementioned experience-knowledge propagation data with one another so as to generate an experience-knowledge propagation graph which is a directed graph as shown in FIG. 19. Thus, experience-knowledge propagation paths are displayed on the screen of the display device 5 of the client 2 or the server 1.

FIG. 19 shows that the experience-knowledge 1 has been propagated to the experience-knowledge 2, and the experience-knowledge 2 has been further propagated to experience-knowledge 3 and experience-knowledge 4, while experience-knowledge 5 has been propagated to experience-knowledge 6. Incidentally, to facilitate understanding, in FIG. 19, the experience-knowledge propagation graph is expressed in diagrammatic form. Practically it is calculated as a mathematical expression such as a matrix.

The distance of each link in the experience-knowledge propagation graph of FIG. 19 indicates a propagation period of the experience-knowledge propagation data. The knowledge relation display processing portion 13b calculates a propagation velocity using propagation periods and a propagation tree (tree indicating a path from one piece of experience-knowledge to a reachable piece of experience-knowledge) of experience-knowledge in the graph.

For example, a propagation velocity v from experience-knowledge k to reachable knowledge i can be calculated in an expression:

v=Σ{(distance between experience-knowledge k and knowledge i)/(number of links between experience-knowledge k and knowledge i)}/S

in which S is a total number of nodes between the experience-knowledge k and the reachable knowledge i in a propagation tree.

For example, in FIG. 19, the distance between the experience-knowledge 1 and the experience-knowledge 2 is 1 (year) and the number of links between them is 1, the distance between the experience-knowledge 1 and the experience-knowledge 3 is 3 (years) and the number of links therebetween is 2, the distance between the experience-knowledge 1 and the experience-knowledge 4 is 1.5 (years) and the number of links therebetween is 2, and the total number of nodes is 4. Accordingly, the propagation velocity of the experience-knowledge 1 can be calculated at v=(3/2+1.5/2+1/1)/3=1.083. Similarly, calculation can be made so that the experience-knowledge 2 has a propagation velocity of 1.25, the experience-knowledge 5 has a propagation velocity of 3 and the other experience-knowledge has a propagation velocity of 0.

Incidentally, as shown in FIG. 20, an average propagation velocity in each enterprise or each organization may be calculated. The knowledge propagation property of an enterprise or an organization can be evaluated due to comparison with other enterprises or organizations based on average experience-knowledge transfer velocities calculated thus.

Next, description will be given to the case in which a process for displaying experience-knowledge associated with business activities and knowledge creation processes and accumulated in the experience-knowledge database 12 in the aforementioned manner is carried out by the knowledge relation display processing portion 13b.

[Individual Experience-Knowledge]

By use of an experience-knowledge extraction result and a corresponding experience-knowledge survey result, each piece of experience-knowledge registered in the experience-knowledge database 12 can be displayed on the screen individually as shown in FIG. 18.

[Experience-Knowledge Map]

Next, description will be made about an experience-knowledge map and a process required for displaying the map. In the experience-knowledge map, the whole of the experience-knowledge registered in the experience-knowledge database 12 is displayed in overview in a form meeting a selection instruction of a user.

FIG. 21 shows an example in which knowledge creation processes and business activities are selected as columns and rows with which a knowledge map is created and displayed two-dimensionally.

A description (211) “2/1” in the map indicates that two pieces of experience-knowledge related to the business activity “catch customer's needs” and the knowledge creation process “socialization” were acquired and one piece was applied. An arrow (210) indicates that knowledge acquired as experience-knowledge related to the business activity “catch customer's needs” and the knowledge creation process “socialization” was applied as the business activity “manage overall internal resources”.

The two-dimensional table shown in FIG. 21 includes the total number of pieces of knowledge acquired or applied in accordance with each business activity and the total number of pieces of knowledge acquired or applied in accordance with each knowledge creation process (SECI). The knowledge analysis portion 13a calculates those total numbers by the aforementioned process. That is, from the experience-knowledge database 12, the knowledge analysis portion 13a calculates the total number of pieces of knowledge by the aforementioned process in accordance with each business activity where the knowledge was acquired or applied. Likewise, the knowledge analysis portion 13a calculates the total number of pieces of knowledge by the aforementioned process in accordance with each knowledge creation process of the knowledge. In such a manner, the two-dimensional table is generated, displayed and outputted.

Incidentally, preferably, a user may use the input device 6 to select a cell (211) or a numerical value on the experience-knowledge map, or select a “knowledge reuse state” menu, so that a knowledge recycle (transition from experience to application) state can be presented to the user, or each piece of experience-knowledge shown in FIG. 18 by way example can be presented to the user. In addition, not only is the arrow (210) presented, but also an experience-knowledge reuse state maybe displayed by animation, moving an indication (212) “•” on the arrow. The color, thickness, etc. of the arrow may be changed so that display can be made in a mode in which the knowledge recycle state in one job category is distinguished from that in another job category.

When such a display method is used, there is an effect that the knowledge recycle state in each job category can be looked over easily.

FIG. 22 shows a modification example of the experience-knowledge map shown in FIG. 21.

In this example, a dot line is drawn between adjacent ones of cells so that display can be made in a mode that experience (acquisition) and application are distinguished from each other. Incidentally, the experience (acquisition) and application of knowledge may be distinguished from each other by a method of changing background colors or background patterns of the cells. In addition, as shown in FIGS. 21 and 22, the number of pieces of experience-knowledge may be calculated and presented in accordance with each category of business activities or knowledge creation processes. When the number of pieces of experience-knowledge is calculated in this manner, there is an advantage that a perspective judgment can be made as to what kind of experience-knowledge a survey target user has acquired from experiences and how the user has applied it.

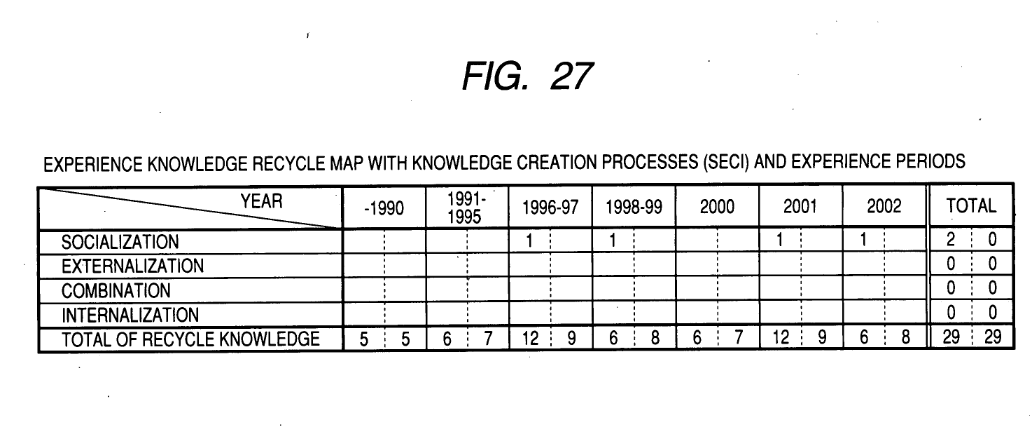

Incidentally, although knowledge creation processes and business activities are shown as columns and rows forming the two dimensions of a knowledge map by way of example, any two dimensions selected from job categories, individuals, organizations, and knowledge acquisition/application periods may be displayed in columns and rows as shown in FIGS. 23 to 27. In addition, when a knowledge map concerning knowledge acquisition/application periods (experience periods) is displayed as shown in FIG. 25, a knowledge recycle state may be expressed in an arrow or by animation in the same manner as the arrow 210. Alternatively, an experience-knowledge propagation graph shown in FIG. 19 maybe displayed overlapping the knowledge map.

The two-dimensional tables shown in FIGS. 23 to 27 include the total number of pieces of knowledge acquired or applied in each business activity, that in each knowledge creation process (SECI), that in each job category, and that in each expression or application period. The knowledge analysis portion 13a calculates those total numbers by the aforementioned process. That is, from the experience-knowledge database 12, the knowledge analysis portion 13a calculates the total number of pieces of knowledge in each business activity where the knowledge was acquired or applied, that in each job category likewise, and that in each period likewise. In addition, the knowledge analysis portion 13a calculates the total number of pieces of knowledge in each knowledge creation process of the knowledge. In such a manner, the two-dimensional table is generated, displayed and outputted.

What is claimed is:

1. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity, information about knowledge acquired from the experience, and information about application of the knowledge;
a unit for associating the information about a personal experience and the information about application of the knowledge with an activity where the experience has been gained;
a unit for associating the information about acquired knowledge with a knowledge creation process expressing a process for creating the knowledge which converts an experience into knowledge; and
a database for classifying by the activity and the knowledge creation process, and storing the information about an experience and information about knowledge and information about application of knowledge.

2. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity and information about knowledge acquired from the experience in a text format;
a dictionary unit for recording words for defining activities; and
an analysis unit for analyzing an inputted text and referring to the dictionary unit to identify an activity corresponding to an experience from which knowledge described in the text has been acquired.

3. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity and information about knowledge acquired from the experience in a text format;
a dictionary unit for recording words for defining knowledge creation processes expressing processes for creating knowledge which convert an experience into knowledge; and
an analysis unit for analyzing an inputted text and referring to the dictionary unit to identify a knowledge creation process corresponding to knowledge described in the text.

4. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity and information about knowledge acquired from the experience in a text format;
a dictionary unit for recording words for defining activities and words for defining knowledge creation processes expressing processes for creating knowledge; and
an analysis unit for analyzing an inputted text and referring to the dictionary unit to identify an activity corresponding to an experience from which knowledge described in the text has been acquired, and a knowledge creation process. corresponding to the knowledge described in the text.

5. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a period of an experience of acquiring knowledge, information about knowledge acquired from the experience, and information about an individual possessing the knowledge;
an analysis unit for analyzing a propagation state of the knowledge among individuals; and
a unit for displaying and outputting the analyzed propagation state of the knowledge.

6. The experience-knowledge information processing apparatus as claimed in claim 5, further comprising:
an analysis unit for calculating a propagation velocity of knowledge among individuals based on the inputted information about a period of an experience.

7. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity, information about knowledge acquired from the experience, and information about application of the knowledge;
an analysis unit for identifying an activity corresponding to an experience from which knowledge has been acquired, and an activity to which the knowledge has been applied; and
a unit for calculating a total number of pieces of knowledge acquired or applied in accordance with each activity.

8. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity, information about knowledge acquired from the experience, and information about application of the knowledge;
an analysis unit for identifying a knowledge creation process which converts an experience into knowledge and a knowledge creation process which applies knowledge to a new activity; and
a unit for calculating a total number of pieces of knowledge acquired or applied in accordance with each knowledge creation process.

9. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity, information about knowledge acquired from the experience, information about application of the knowledge, information about a job category where the experience has been gained, and information about a job category to which the knowledge has been applied; and
a unit for calculating a total number of pieces of knowledge acquired or applied in accordance with each job category.

10. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity, information about knowledge acquired from the experience, and information about application of the knowledge;
an analysis unit for identifying an activity corresponding to an experience from which knowledge has been acquired or an activity to which the knowledge has been applied, and identifying a knowledge creation process of the knowledge acquired from the experience;
a unit for calculating a total number of pieces of knowledge acquired or applied in accordance with each activity and each knowledge creation process; and
a unit for displaying the calculated total number of pieces of knowledge in a two-dimensional table with activities and knowledge creation processes in columns and rows.

11. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity, information about knowledge acquired from the experience, information about application of the knowledge, and information about a job category where the experience has been gained or the knowledge has been applied;
an analysis unit for identifying an activity where knowledge has been acquired from an experience or the knowledge has been applied, and identifying a job category where the experience has been gained or the knowledge has been applied;
a unit for calculating a total number of pieces of knowledge acquired or applied in accordance with each activity and each job category; and
a unit for displaying the calculated total number of pieces of knowledge in a two-dimensional table with activities and job categories in columns and rows.

12. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity, information about knowledge acquired from the experience, information about application of the knowledge, and information about a job category where the experience has been gained or the knowledge has been applied;
an analysis unit for identifying a knowledge creating process of knowledge acquired from an experience and a knowledge creating process which applies knowledge to a new activity;
a unit for calculating a total number of pieces of knowledge acquired or applied in accordance with each job category and each knowledge creation process; and
a unit for displaying the calculated total number of pieces of knowledge in a two-dimensional table with job categories and knowledge creation processes in columns and rows.

13. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity, information about knowledge acquired from the experience, information about application of the knowledge, and information about a period of the experience in which the knowledge has been acquired or applied;
an analysis unit for identifying an activity corresponding to an experience where knowledge has been acquired or an activity where the knowledge has been applied; a unit for calculating a total number of pieces of knowledge acquired or applied in accordance with each activity and each period; and
a unit for displaying the calculated total number of pieces of knowledge in a two-dimensional table with activities and periods in columns and rows.

14. An experience-knowledge information processing apparatus that manages knowledge based on personal experiences for reuse of knowledge which converts an experience gained from a past activity into knowledge by a knowledge creation process and applies the knowledge to a new activity, comprising:
a unit for inputting information about a personal experience gained from a past activity, information about knowledge acquired from the experience, information about application of the knowledge, and information about a period of the experience in which the knowledge has been acquired or applied;
an analysis unit for identifying a knowledge creation process of knowledge acquired from an experience, and a knowledge creation process where the knowledge has been applied;
a unit for calculating a total number of pieces of knowledge acquired or applied in accordance with each knowledge creation process and each period; and
a unit for displaying the calculated total number of pieces of knowledge in a two-dimensional table with knowledge creation processes and periods in columns and rows.

15. A program for making a computer execute a knowledge management process based on personal experiences, the computer executing the knowledge management process for reuse of knowledge which converts an experience gained from a past activity into knowledge by a knowledge creation process and applies the knowledge to a new activity based on inputted information including information about a personal experience gained from a past activity, information about knowledge acquired from the experience and information about application of the knowledge, the knowledge management process including:
associating the information about a personal experience and the information about application of the knowledge with an activity where the experience has been gained;
associating the information about acquired knowledge with a knowledge creation process expressing a process for creating the knowledge which converts an experience into knowledge; and
classifying by the activity and the knowledge creation process, and storing the information about a personal experience, information about acquired knowledge about application of information in a database.

16. A program for making a computer execute a knowledge management process based on personal experiences, the computer executing the knowledge management process for reuse of knowledge which converts an experience gained from a past activity into knowledge by a knowledge creation process and applies the knowledge to a new activity based on inputted information including information about a personal experience gained from a past activity, information about knowledge acquired from the experience and information about application of the knowledge, the knowledge management process including:
identifying an activity where the knowledge has been acquired from the experience, and an activity where the knowledge has been applied; and
calculating a total number of pieces of knowledge acquired or applied in accordance with each activity.

17. A program for making a computer execute a knowledge management process based on personal experiences, the computer executing the knowledge management process for reuse of knowledge which converts an experience gained from a past activity into knowledge by a knowledge creation process and applies the knowledge to a new activity based on inputted information including information about a personal experience gained from a past activity, information about knowledge acquired from the experience and information about application of the knowledge, the knowledge management process including:
identifying a knowledge creation process in which the knowledge has been acquired by converting from the experience and a knowledge creation process in which the knowledge has been applied to a new activity; and
calculating a total number of pieces of knowledge acquired or applied in accordance with each knowledge creation process.

18. A program for making a computer execute a knowledge management process based on personal experiences, the computer executing the knowledge management process for reuse of knowledge which converts an experience gained from a past activity into knowledge by a knowledge creation process and applies the knowledge to a new activity based on inputted information including information about a personal experience gained from a past activity, information about knowledge acquired from the experience, information about application of the knowledge, information about a job category where the experience has been gained, and information about a job category to which the knowledge has been applied, the knowledge management process including:
calculating a total number of pieces of knowledge acquired or applied in accordance with each job category.

19. A program for making a computer execute a knowledge management process based on personal experiences, the computer executing the knowledge management process for reuse of knowledge which converts an experience gained from a past activity into knowledge by a knowledge creation process and applies the knowledge to a new activity based on inputted information including information about a period of a personal experience gained from a past activity, information about knowledge acquired from the experience, and information about an individual possessing the knowledge, the knowledge management process including:
analyzing a propagation state of the knowledge among individuals; and
displaying and outputting the analyzed propagation state of the knowledge.

20. The program as claimed in claim 19, the knowledge management process further including:
calculating a propagation velocity based on the propagation state of the knowledge among the individuals.

21. An experience-knowledge information processing method that manages knowledge based on personal experiences for reuse of knowledge which converts an experience gained from a past activity into knowledge by a knowledge creating process and applies the knowledge to a new activity, comprising:
analyzing an inputted electronic data text by a computer process including information about a personal experience gained from a past activity, information about knowledge acquired from the experience and information about application of the knowledge;
associating by a computer process the information about a personal experience and the information about application of the knowledge with an activity where the experience has been gained; and
associating by a computer process the information about acquired knowledge with a knowledge creation process expressing a process for creating the knowledge which converts an experience into knowledge.

22. An experience-knowledge information processing method that manages knowledge based on personal experiences for reuse of knowledge which converts an experience gained from a past activity into knowledge by a knowledge creating process and applies the knowledge to a new activity, comprising:
analyzing an inputted electronic data text by a computer process including information about a personal experience gained from a past activity, information about knowledge acquired from the experience and information about application of the knowledge;
identifying an activity by a computer process where knowledge has been acquired from an experience and an activity where the knowledge has been applied; and
calculating by a computer process a total number of pieces of knowledge acquired or applied in accordance with each activity.

23. An experience-knowledge information processing method that manages knowledge based on personal experiences for reuse of knowledge which converts an experience gained from a past activity into knowledge by a knowledge creating process and applies the knowledge to a new activity, comprising:
analyzing an inputted electronic data text by a computer process including information about a personal experience gained from a past activity, information about knowledge acquired from the experience and information about application of the knowledge;
identifying a knowledge creation process by a computer process where the knowledge has been acquired by converting from the experience and a knowledge creation process where knowledge has been applied to a new activity; and
calculating by a computer process a total number of pieces of knowledge acquired or applied in accordance with each knowledge creation process.

24. An experience-knowledge information processing method that manages knowledge based on personal experiences for reuse of knowledge which converts an experience gained from a past activity into knowledge by a knowledge creating process and applies the knowledge to a new activity, comprising:
analyzing an inputted electronic data text by a computer process including information about a personal experience gained from a past activity, information about knowledge acquired from the experience, information about application of the knowledge, information about a job category where the experience has been gained, and information about a job category to which the knowledge has been applied; and
calculating by a computer process a total number of pieces of knowledge acquired or applied in accordance with each job category.

25. An experience-knowledge information processing method that manages knowledge based on personal experiences for reuse of knowledge which converts an experience gained from a past activity into knowledge by a knowledge creating process and applies the knowledge to a new activity, comprising:
analyzing an inputted electronic data text by a computer process including information about a period of an experience gained from a past activity, information about knowledge acquired from the experience and information about an individual possessing the knowledge;
analyzing by a computer process a propagation state of the knowledge among individuals; and
displaying and outputting by a computer process the analyzed propagation state of the knowledge.

26. The experience-knowledge information processing method as claimed in claim 25, further comprising:
calculating a propagation velocity by a computer process based on the propagation state of the knowledge among the individuals.
